(19) United States
(12) Patent Application Publication
(10) Pub. No.: US 2024/0211470 A1
(43) Pub. Date: Jun. 27, 2024

(54) SMART SIGNALING FOR NEVER STALE CACHING

(71) Applicant: Ping Identity International, Inc., Denver, CO (US)

(72) Inventor: Dirk John Hogan, West Linn, OR (US)

(73) Assignee: Ping Identity International, Inc., Denver, CO (US)

(21) Appl. No.: 18/587,864

(22) Filed: Feb. 26, 2024

Related U.S. Application Data
(63) Continuation-in-part of application No. 18/114,688, filed on Feb. 27, 2023.
Application No. 18/114,688 is a continuation of application No. 17/018,074, filed on Sep. 11, 2020, now Pat. No. 11,593,356.
(60) Provisional application No. 63/618,227, filed on Jan. 5, 2024.

(51) Int. Cl. G06F 16/23; G06F 12/0875; G06F 16/901; G06Q 10/067; G06Q 10/105; G06Q 10/109

(52) U.S. Cl. CPC G06F 16/2379; G06F 12/0875; G06F 16/9024; G06Q 10/105; G06Q 10/109; G06F 2212/1032; G06Q 10/067

(57) ABSTRACT

The technology disclosed relates to reducing forwarding of notifications from a current vertex of a current vertex class by performing a next-hop analysis in a graph with a schema defining at least two classes of vertices with at least one vertex class caching relationship derived virtual properties (“RDVPs”) and how vertices of the vertex classes forward the notifications.

The technology involves having, at the current vertex, a notification, ascertaining, from the relationships between the current vertex and target vertices that are connected in one hop, the vertex classes of the target vertices. The current vertex conditionally forwards notifications to vertices of other vertex classes dependent on the next-hop analysis. The next hop analysis is satisfied when the target vertex is configured to update an RDVP cache based on a relationship path or the target vertex is configured to propagate notifications to a further vertex.

### PRIORITY APPLICATIONS

This application claims priority as a continuation-in-part of co-pending U.S. Patent application Ser. No. 18/114,688 titled “Never Stale Caching of Effective Properties,” filed 27 Feb. 2023 (Atty. Docket No. FORG 1008-2) which is a continuation of U.S. patent application Ser. No. 17/018,074, filed 11 Sep. 2020, now U.S. Pat. No. 11,593,356, issued 28 Feb. 2023 (Atty. Docket No. FORG 1008-1). This application also claims priority to and the benefit of U.S. Provisional Application No. 63/618,227 titled “Smart Signaling For Never Stale Caching,” filed 5 Jan. 2024. The priority applications are hereby incorporated by reference herein for all purposes.

### FIELD OF INVENTION

The technology disclosed relates to updating caches of graph properties. It can be used in conjunction with identity management as well as other graph management applications. In particular, it relates to propagating attribute update notifications to parts of the graph where they will induce a vertex state change, while avoiding propagating attribute update notifications that will not induce a vertex state change. This allows for improved scaling of the graph.

### INCORPORATION BY REFERENCE OF FILE SUBMITTED ELECTRONICALLY WITH APPLICATION

The following file in ASCII text format is submitted with this application as Appendix A and is incorporated by reference.

| File name | Creation date | Size |
|---|---|---|
| IDM MANAGED JSON | Dec. 18, 2023 | 85.4 KB. |

### BACKGROUND

The technology disclosed relates to smart signaling in never stale caching.

Never-stale caching technology has become popular with customers. The technology is so useful that customers are interested in extending Identity Management (IDM) structures beyond the user-role-assignments described in Never Stale Caching of Effective Properties, U.S. Pat. No. 11,593,356. The never-stale caching structure can be extended to specific IDM use cases, or even beyond IDM such as management of devices in the Internet of Things.

The extensions, adjustments, and adaptations have complicated updating of caches and triggered unnecessary update queries. This hinders scaling the technology.

An opportunity arises for smart signal analysis to reduce propagation of notification signals and triggering of update queries that do not result in cache updates. Smart signal analysis improves scaling of models to large numbers of vertices and edges.

### BRIEF DESCRIPTION OF THE DRAWINGS

FIG. 1 is an architectural level block diagram of a system utilizing never stale caching of effective properties with smart signaling.

FIG. 2 illustrates graph management system of FIG. 1 in greater detail.

FIG. 3 is an example graph of vertices or nodes and edges or relationships that connect the vertices, in a user-role-assignment use case.

FIG. 4A excerpts lines of code from a schema from which the example graph of FIG. 3 is implemented.

FIG. 4B is a continuation of the FIG. 4A schema excerpts.

FIGS. 5A through 5E illustrate, through a general scenario, an example of next-hop analysis used in smart signaling.

FIG. 5A illustrates the overview of vertex classes in the general scenario.

FIG. 5B illustrates schema excerpts of class Z, a class that configures signal initiation vertices.

FIG. 5C illustrates schema excerpts of class Y, a class that configures propagator vertices.

FIG. 5D illustrates schema excerpts of class X, a class that configures cache vertices.

FIG. 5E illustrates schema excerpts of class W, another class that configures other cache vertices.

FIG. 6 illustrates a graph database.

FIG. 7 illustrates a graph for a scenario of managing software access.

FIG. 8 illustrates an organizational chart for a scenario of signaling across multiple organizations. The scenario can illustrate, by contrasting examples within the scenario, how smart signaling can reduce unnecessary notifications.

FIGS. 9A-D illustrate schema excerpts for vertex class organization and vertex class user. FIG. 9A begins schema excerpts for the class “organization”. FIG. 9B continues FIG. 9A. FIG. 9C concludes schema excerpts for the class “organization”, and begins schema excerpts for the class “user”. FIG. 9D concludes schema excerpts for “user”.

FIGS. 10A and 10B partially illustrate organizations, users, and properties of organizations and users from the org chart in FIG. 8, consistent with the schema in FIG. 9.

FIGS. 11A-11B illustrate updated vertices after the “new_root” value has been added to the RDVP cache of all the “orgN” and all the “userN” vertices in FIGS. 10A-10B.

FIGS. 12A-12B illustrate further updated vertices after the user99 has been added as owner of org0 and RDVP caches of organization vertices have been updated.

FIG. 13 is a block diagram of an example computer system.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

A prior application family entitled “Never Stale Caching of Effective Properties” described a method of caching effective attributes at vertices and, more importantly, updating the caches based on changes to edges and attributes of edge-connected vertices, from which effective attributes were derived. The effective attributes cached can be called Relationship Derived Virtual Properties (RDVPs).

Applicant's prior patent explained that RDVP caches are generally applicable to graphs and propagation of derived properties over edges among vertices of a graph. General application of RDVP caches gained commercial popularity and substantial success. The earliest use case involved graphs of users-roles-assignments, with user nodes having RDVP caches of attributes derived from their connection through roles to assignments. In a large population of users, such as 10,000 users, with numerous roles, RDVP caching greatly streamlines computing for identity management and identity-relationship management. In some extended use cases, users belonged to groups, apart from a line reporting structure, such as engineering disciplines in a matrix-management organization structure. Similarly, user groups were organized around administrative responsibilities and corresponding tools. These alternative edge connections among vertices impacted cache updating.

Additional extensions of this technology included graphs of users-roles-application and users-applications. In these graphs, applications included cloud-based SaaS platforms such as Saleforce, Mailchimp, Slack, DocuSign, and Tableau. Organizations routinely need to provision their users for SaaS applications. Provisioning of SaaS resources presents different requirements and updating patterns than the provisioning on-site resources, referred to as assignments. In some implementations, vertices for users are connected into graphs of both users-roles-assignments for internal resources and users-roles-applications for SaaS resources.

Beyond user scenarios, graphs with RDVP caches apply to the IoT, including graphs for luxury automobiles. An automobile can have feature, driver and maintenance graphs, for instance. It should be apparent that different graphs over users or IoT devices can present divergent update patterns.

The technology disclosed addresses a problem that arose from extended use cases, from updating requirements in graphs that have more relations than the users-roles-assignments graph. Applicant found use cases in which more than 90 percent of the connected vertices that were notified of changes that potentially triggered update queries either did not act on a notice received or triggered a query that failed to update the vertex's cache. A large proportion of vertices did not act on notice of an updated attribute, did not either by propagate a signal onward or update an RDVP cache responsive to the updated attribute. Accordingly, the technology disclosed averts notification to vertices that effectively don't care. The technology disclosed filters notifications on a next-hop basis, taking into account both propagator and consumer/RDVP cache update characteristics of target vertices.

The technology disclosed involves evaluating whether a target vertex for potential notification is a propagator, a consumer, or both a propagator and consumer. In this application, a propagator is a vertex that propagates an update signal onward across additional edges, beyond the edge that connects transmitter and target vertices, to vertices at least one degree removed from the transmitter vertex and often to vertices two or more degrees removed. A consumer has an RDVP cache that is recalculated and updated responsive to the notification.

Whether a target vertex is a propagator or consumer is captured in the schema for its vertex class. The schema can be retained in memory and accessed more readily than traversing edges to reach individual vertices in the graph. The transmitter vertex begins by updating itself based on the signal it receives, either over an edge or due to direct updating of the transmitter vertex. Upon updating, it detects which attributes have been updated. For each target vertex connected by an edge to the transmitter vertex, a filtering process determines whether the target vertex acts upon the attribute that has been updated. For propagation, the filtering process consults the schema and determines whether the schema calls for the target vertex to propagate the changed attribute onward to at least one vertex separated by one degree from the transmitter vertex. If the schema for the target vertex specifies that the relationship field on the target vertex through which the notification would be received and is configured to propagate this notification onward, over an edge for another relationship field, then this target vertex is considered a propagator, and thus the notification is dispatched to this target vertex. The propagation obligation set in the schema is one circumstance in which the filter process passes the signal over the edge to the target vertex. The other circumstance involves the target vertex updating an RDVP cache responsive to the update.

The response of the RDVP cache at a target vertex to an updated attribute is defined in the schema for the RDVP cache of the target vertex. Again, this schema is retained in memory and accessed more readily than traversing edges to reach individual vertices. As above, the transmitter vertex begins by updating itself based on the signal it receives, either over an edge or due to direct updating of the transmitter vertex. Upon updating, it detects which attributes have been updated. For each target vertex connected by an edge to the transmitter vertex, a filtering process determines whether the target vertex acts upon the attribute that has been updated. For RDVP cache updating, the filtering process consults the schema and determines that the target vertex maintains an RDVP cache and determines whether the schema calls for the target vertex to recalculate its RDVP cache based on the changed attribute. If the target vertex has an RDVP cache that, according to the schema, is recalculated based on the attribute update, then the transmitter forwards the notification to the target vertex.

Both manners of acting upon an updated attribute can be filtered on a next-hop basis from the schema, whether the schema is in memory or retrieved from storage. At an upper level of a tree, averting propagation of a signal over one edge can eliminate traversal of that signal over dozens, hundreds or thousands of edges. The filtering process has more leverage at higher branches of a tree than at terminal branches that connect only to consumer vertices, from which none of the connected vertices are propagators. Along every path through the tree, filtering based on whether connected vertices will act on a change attribute is likely to efficiently save on resources required for edge traversal to and cache update calculations at connected vertices.

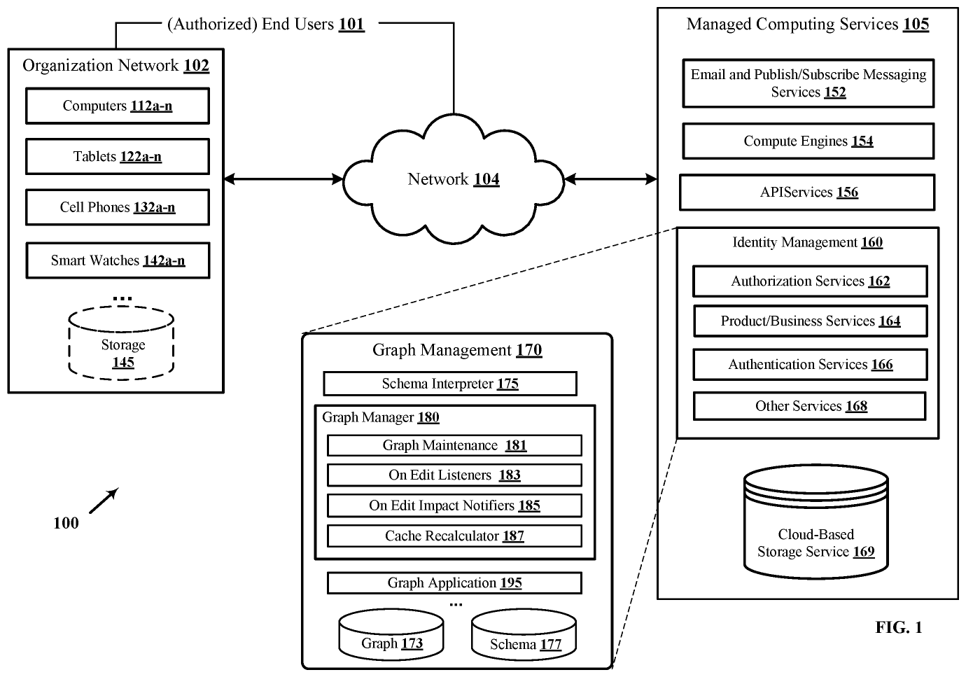

FIGS. 1-3 are repeated from Applicant's prior application. FIG. 1 is a high-level block diagram of an example system that uses the technology disclosed. As a high-level diagram, some components are omitted to emphasize innovative features of the technology disclosed.

System 100 includes an organization network 102 of a business or other organization with computers 112a-n that provide end user access to resources provided by managed computing services 105, or further, to resources provided by organization network 102 and/or other services from providers external to managed computing services (not shown). End users 101 can include local or remote end users seeking to access resources via ones of computers 112a-n, tablets 122a-n, cell phones 132a-n, smart watches 142a-n, and/or virtual/augmented reality (not shown) and/or other computing devices. Browser-based applications can, for example, be used by such computing devices alone or in combination to communicate via network 104 with managed computing services 105. Browser-based applications can, for example, be delivered to these and/or other devices not mentioned here by managed computing services 105, and can utilize security and/or other protocols in accordance with the requirements of a particular application. Network 104 can, for instance, include private networks and/or public networks such as the Internet.

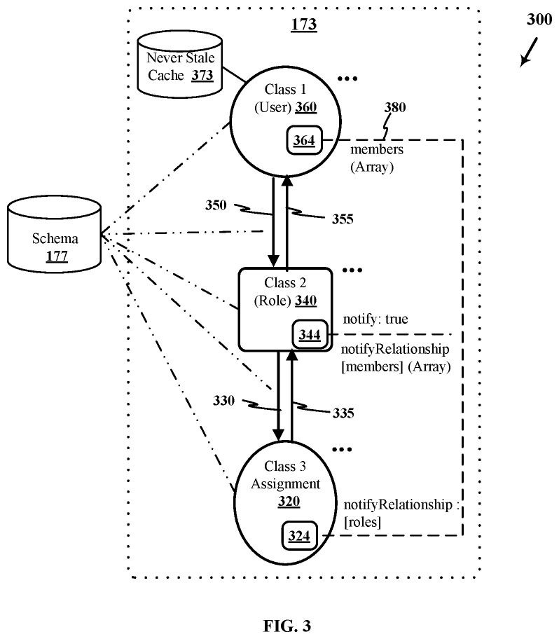

Managed computing services 105 include cloud-based managed services provided by a managed services provider that is trusted third party with respect to organization network 102. Managed services 105 include identity management 160. Identity management 160 can include managed services for identifying, authenticating and/or authorizing individuals or groups of users in conjunction with providing them access to applications, systems, networks, storage and/or other services. As shown, identity management 170 includes authorization services 162, a subset of which are used as examples for conveying an understanding of various aspects of the invention, beginning with FIG. 3. Identity management 170 can also include product/business services 164, authentication services 166, storage services 169 and/or other managed services 168. It will become apparent that identity management according to the invention has broad application for relating users and resources. Identity management can include one or more, or even all of the illustrated and/or other managed computing services, or can be utilized in conjunction with ones of managed computing services. Managed computing services 105 also include email and publish/subscribe services 152, compute engines 154, application program interface or API services 156 and cloud-based storage services 169, and can further include other services. Such services can, for example, include but are not limited to business process services, graph management services 170, and other services relating to the operations, implementations, transactions and/or other interactions of individuals/groups, businesses, products/services, and so on. Managed computing services 105 can provide all or a portion of such services directly. Managed computing services 105 can also act as an intermediary, conducting identity management 160 for services provided by organization network 102 and/or other service providers (not shown) that can, for example, be coupled to managed computing services 105 via network 104 for providing such services.

Graph management supports utilizing a graph, for example, in conjunction with identity management or identity management related services. Graph management can include but is not limited to designing, creating, changing, replacing and/or other aspects of graph management, in addition to the examples specifically provided. Graph management can, for example, be utilized for individual/collaborative end user creation, customization and/or adaptation of graphs, schema, related programs/designs and/or analyses, entry of updates to the graphs, and so on.

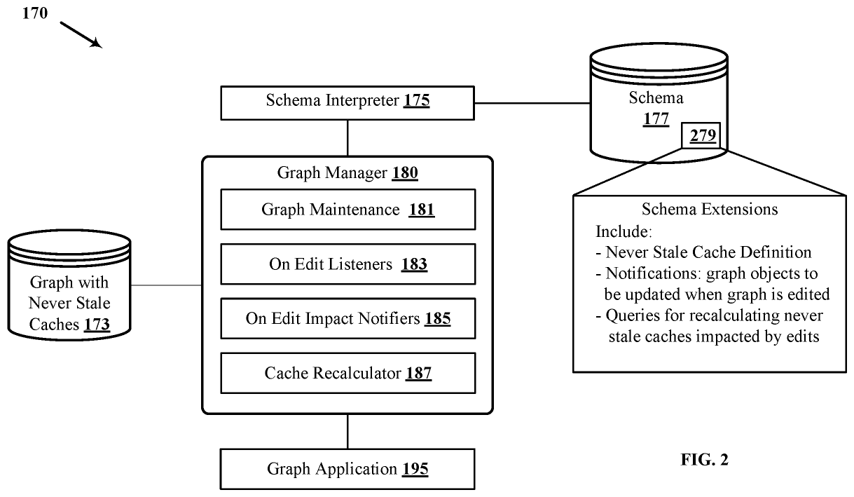

Graph management 170 provides for configuring, from a schema, structures and maintenance methods for calculating effective attributes, refreshing never stale caches, etc., which can be used in conjunction with identity management and other graphs. Maintenance includes configuring notification requirements applicable to the updating of attributes of vertices in an identity management or other graph, and to the updating of topology of the graph by adding or deleting vertices and/or edges in the graph. Graph management 170 also provides for detecting an update to an attribute or topology that is subject to a configured notification requirement, and for refreshing vertices in a class of vertices that is subject to the configured notification requirement and connected in the graph by one or more edges and vertices to the updated vertex or edge. Graph management 170 includes schema interpreter 175, graph manager 180 and graph application 195, as well as a graph 173 with one or more never stale caches, and schema 177. Graph manager 180 further includes graph maintenance 181, on edit listeners 183, on edit impact notifiers 185 and a cache recalculator 195, which are described in greater detail beginning with FIG. 2.

In the interconnection of the elements of system 100, network 104 couples computers 112a-n, tablets 122a-n, cell phones 132a-n, smart watches 142a-n, organization network 102, authorization server 105 and resource server 148 in communication. The communication path can be point-to-point over public and/or private networks. Communication can occur over a variety of networks, e.g. private networks, VPN, MPLS circuit, or Internet, and can use appropriate application program interfaces (APIs) and data interchange formats, e.g. REST, JSON, XML, SOAP. The communications can be encrypted. This communication is generally over a network such as the LAN (local area network), WAN (wide area network), telephone network (Public Switched Telephone Network (PSTN), Session Initiation Protocol (SIP), wireless network, point-to-point network, star network, token ring network, hub network and/or Internet, inclusive of the mobile Internet, via protocols such as EDGE, 3G, 4G LTE, Wi-Fi, and WiMAX.

FIG. 2 illustrates graph management 170 of FIG. 1 in greater detail. Schema 177 defines a graph 173 and operations on graph 173. Graph 173 includes never stale caches in all vertices in a class of vertices. A never stale cache allows lookup of vertex properties that are derived from vertex state in the connected graph topology. For instance, a never stale cache can be maintained at a user vertex, such that, in a user-role-assignment use case, queries for user assignment state can be looked up in the never stale cache, and without navigating the graph topology. In other cases, never stale caches can be maintained at vertices in any given vertex class, thereby providing similar query optimizations in accordance with the requirements of a particular application.

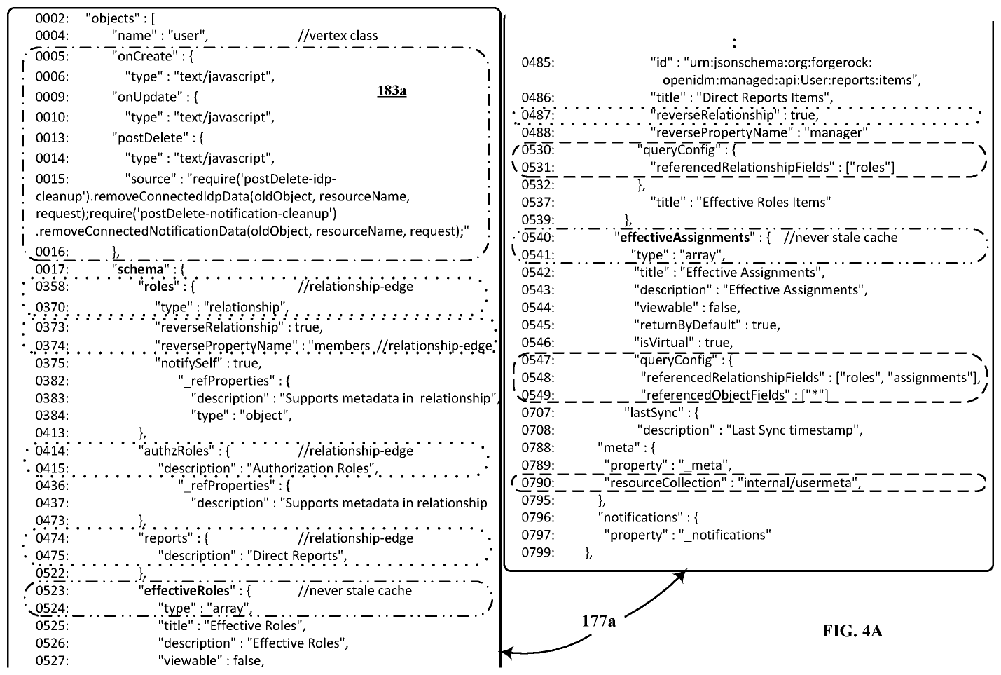

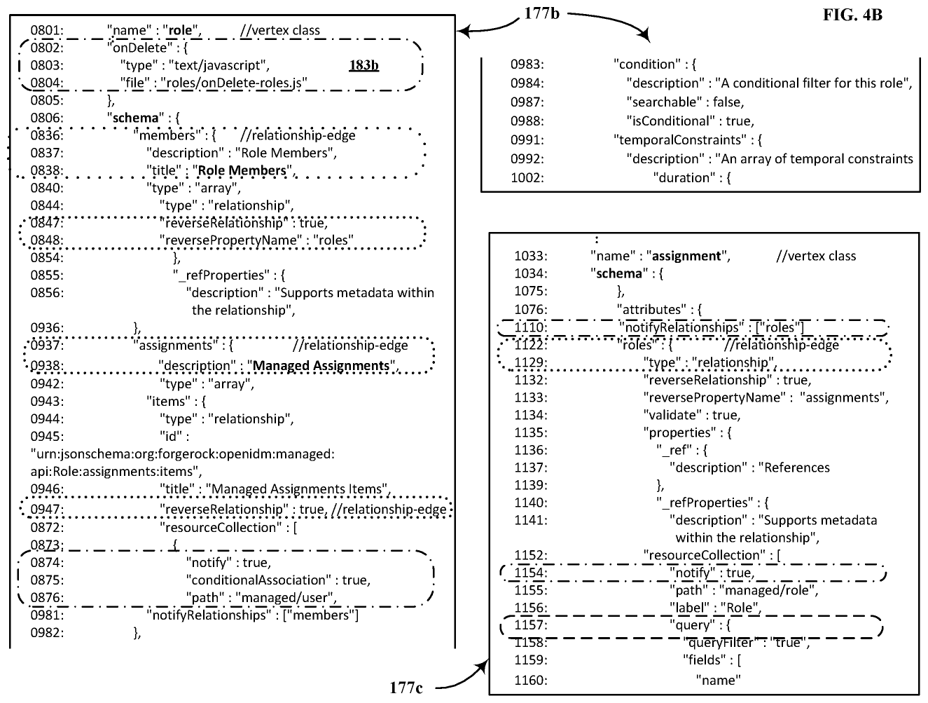

Schema 177 is extended beyond a typical schema to include definition of the never stale cache, so-called notifications of graph objects to be refreshed when the graph is edited, and queries for recalculating the never stale caches that are impacted by edits. Schema 177 is further described in the context an example graph in FIG. 3 and example schema excerpts in FIGS. 4A and 4B for identity management of users, roles that the users have, and assignments that indicate permissions assigned to the roles.

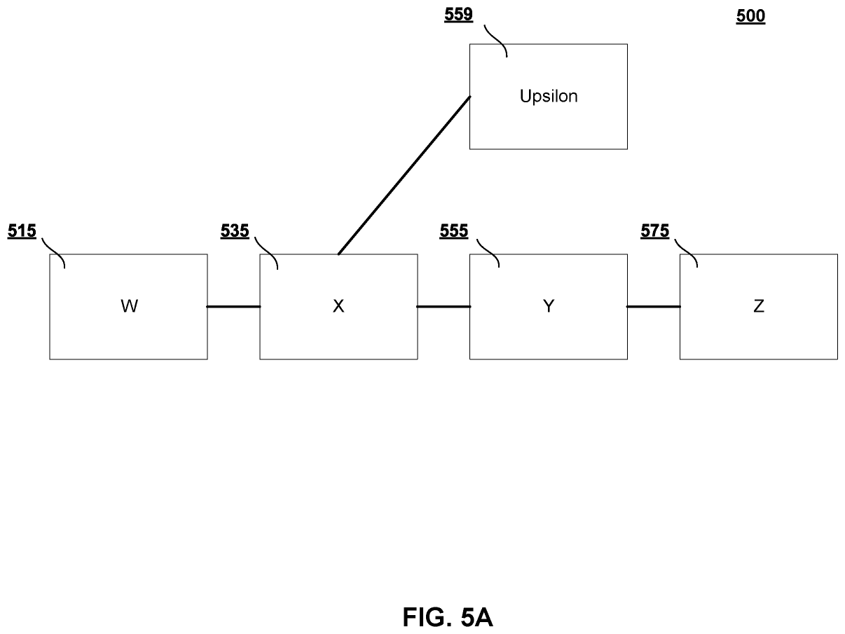

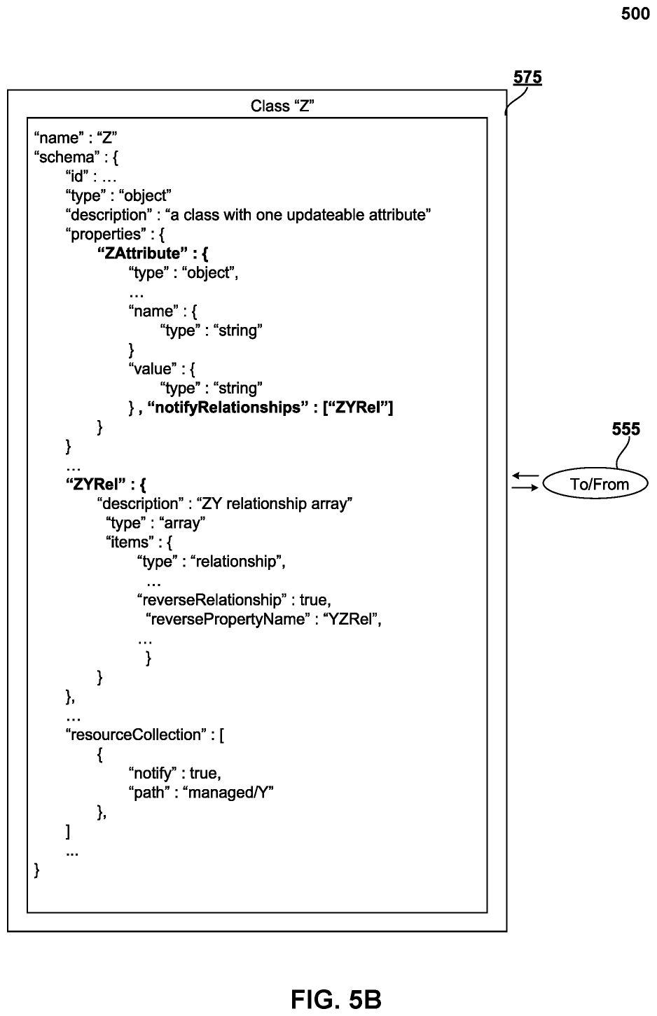

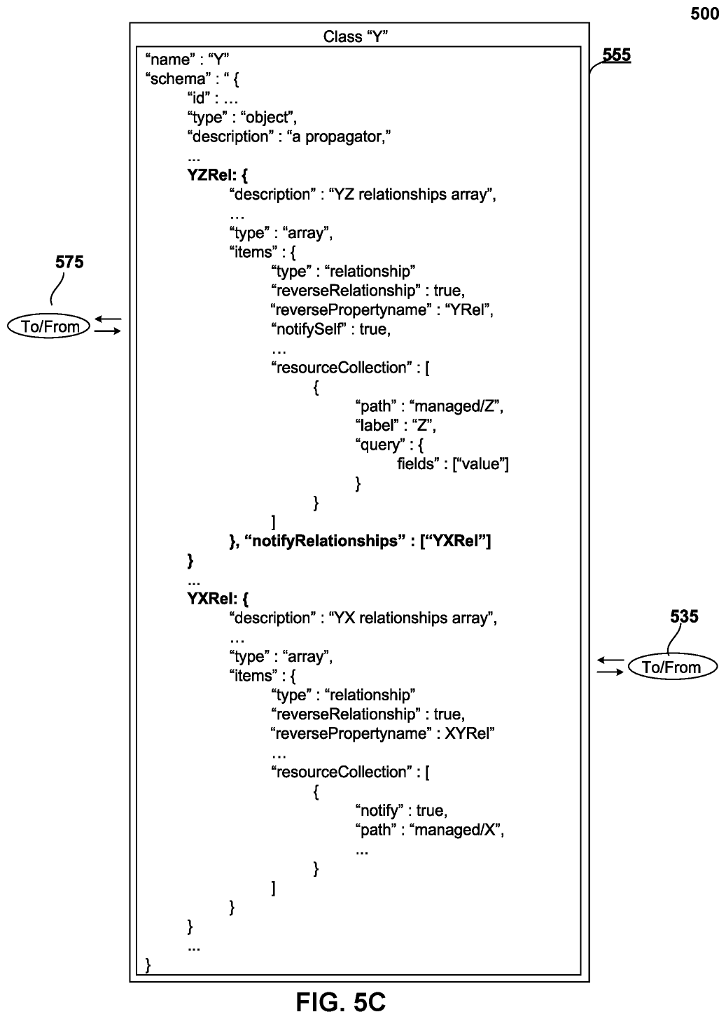

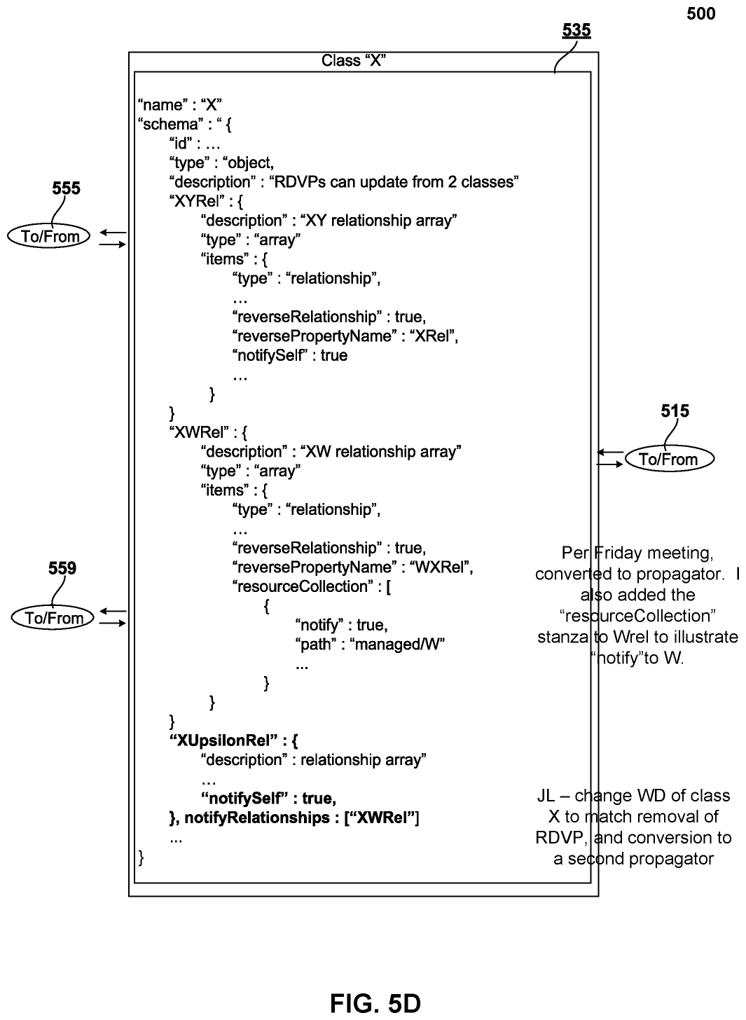

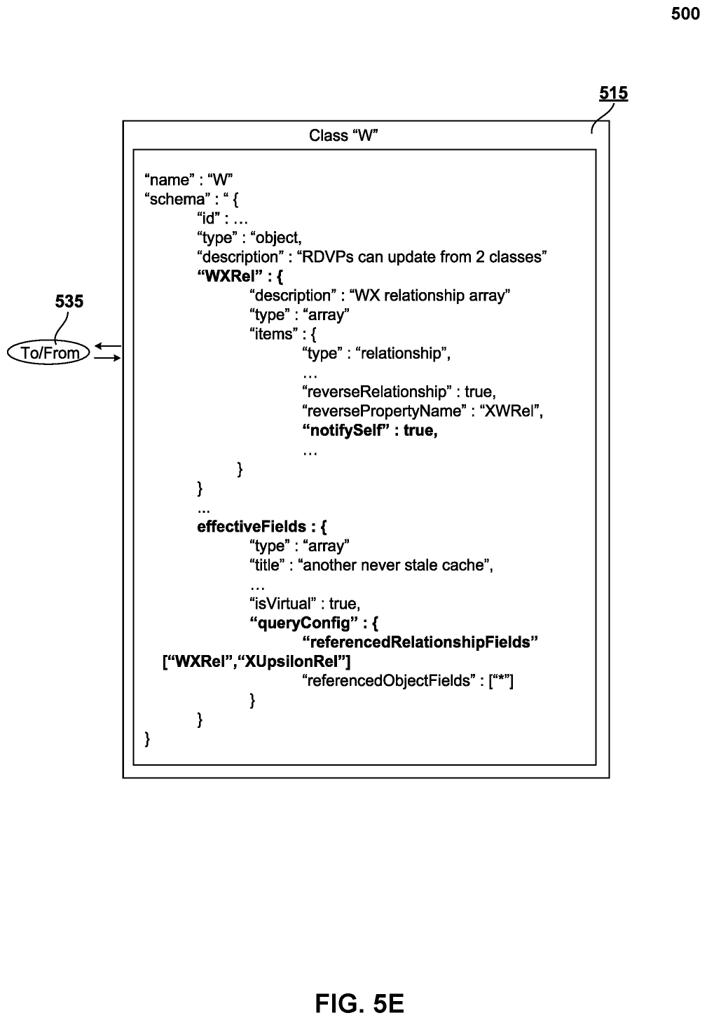

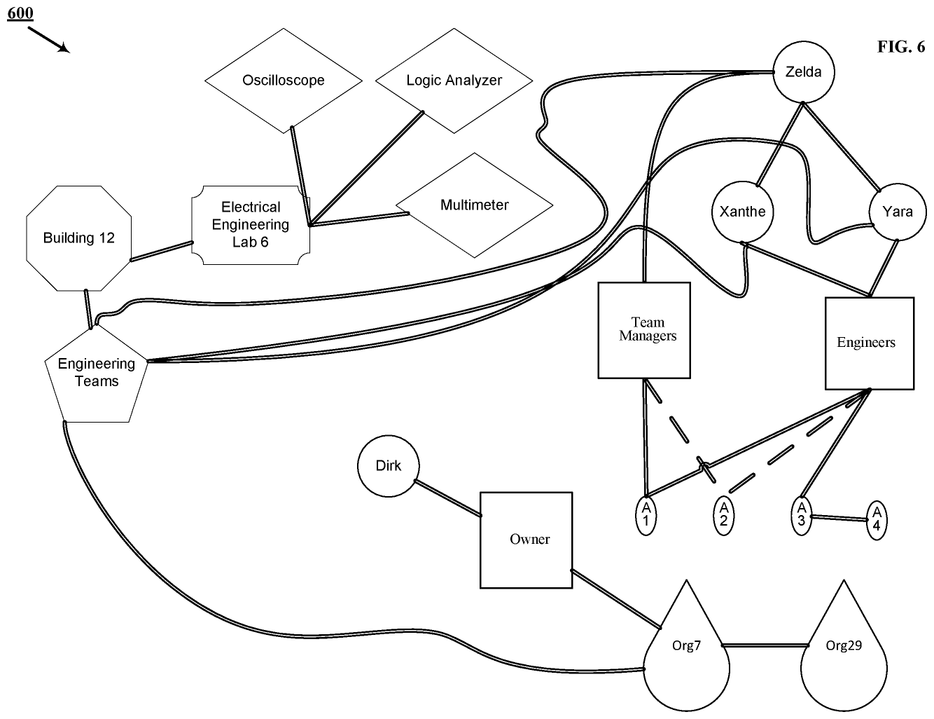

The primary use case that runs through these figures involves an identity management graph with vertices or nodes for users, roles and assignments or applications. FIGS. 5A and 5B present a further example identity graph and example schema excerpts illustrating an alternative use case overlaid on the identity management graph of FIG. 3 and schema of FIGS. 4A and 4B. This alternative use case tracks reporting relationships within a multi-layered organization. FIG. 6 illustrates how graph management 170 also provides for refreshing effective attributes and maintaining a never stale cache in conjunction with and further utilizing additional graph customizability, and other use case examples employing graph management 170 in conjunction with various graphs and graph utilizations are also provided.

FIG. 3 provides an example used to introduce RDVP never-stale caching. Example graph 173 of FIG. 3, for example, includes vertices or nodes, and edges or relationships, which connect the vertices in the user-role-assignment use case. The vertices and edges are collectively referred to as objects. Objects in graph 173 include vertices 320, 340 and 360, and edges 330, 335, 350 and 355. Attributes or properties can be loaded on any of these vertex or edge objects, and never stale caches can be maintained on any of the objects. One use case has the never stale caches on user vertices. More than one never stale cache can be maintained at a user vertex, such as caches for roles and assignments, as explained in the discussion below of an example schema. Never stale caches can be maintained at any vertex class and are ultimately defined by the relationship fields traversed from the cache host vertex to reach the vertices whose properties will populate the never stale cache. Vertices are defined as a specific object class, and this definition includes the relationship fields which define the edges which link to other (or the same) vertex classes. The schema includes notification configurations, which dictate how edge or vertex property updates are propagated across the graph. This allows specific graph topology changes to be signaled across this graph topology to vertex classes affected by these topology changes. Signal receipt is used to traverse this same graph topology, generally in the direction opposite to signal propagation, to traverse the vertex instances whose state will populate the never-stale caches on the notified vertex instances. As applied to a user-role-assignment use case of identity management, for example, users can have associated roles and roles can have associated assignments or permissions. Users define two never-stale caches corresponding to the roles and assignments connected to a given user: effectiveRoles and effectiveAssignments, respectively. Both the effectiveRoles and effectiveAssignments RDVP cache arrays are populated by traversing the roles and assignments linked to a given user.

In one IDM implementation, the schema definitions configure numerous classes generally related to graph vertices and graph edges. In IDM parlance, graph vertices are called managed objects. One of the primary concerns of IDM is to be able to model a given customer's business domain, which is effectively modeled using the object types and corresponding relationships defined the schema. This state is used to instantiate the numerous classes that ultimately expose a corresponding REST endpoints, which are used to manipulate the vertices and edges in this graph. Part of this manipulation involves notification by signal generation and propagation, and signal receipt triggers recalculation of the vertex properties encapsulating selected elements of graph topology state—e.g. effectiveRoles and effectiveAssignments.

Returning to FIG. 2, schema interpreter 175 interprets schema 177 according to schema elements and configures data used by other components of the graph manager 180, including graph maintenance 181 and one or more on-edit listeners 183, edit impact notifiers 185 and cache recalculator 187, and by graph application 195. Schema interpreter 175 identifies objects or classes of objects that have never stale caches and assembles data used to build and maintain those caches. For on-edit listeners 183, schema interpreter identifies classes of objects for which notifications are triggered or otherwise required upon editing of attributes or topology. For edit impact notifiers 185, the schema interpreter identifies the class(es) of edges to trace and the class(es) of edges to which they connect, in order to determine which never stale caches should be refreshed due to user updates that update object attributes or add or delete object of the graph. Edit impact notifiers 185 compile lists of objects for which respective never stale caches will be refreshed or evaluated for refreshing, and provides for notifying impacted objects to refresh their caches. For cache recalculator 187, the schema interpreter provides data from the schema regarding how to traverse the graph and what attributes to accumulate in order to recalculate the never stale cache. For instance, for user vertices, schema interpreter 175 provides data from the schema that indicates how to traverse roles and how to traverse from roles to assignments in order to calculate effective roles and effective assignments stored in never stale caches of the user vertices. More generally, the schema interpreter can configure, from the schema, the data used to build a graph, maintain the graph and refresh never stable caches in graph objects, not limited to identity management.

Graph application 195 queries the graph for effective attributes that can be stored in and looked up from the never stale caches. In the use case of an identity management graph with users, roles and assignments, the identity management graph application queries a user vertex for effective assignments. The query can be answered via lookup in the never stale cache, without needing to navigate the graph and without needing to join roles and assignments in order to calculate effective assignments of the user. Because the never stale cache is refreshed when edits take place and are detected by graph management 170, for instance, when an on-edit listener 183 is triggered, the requested effective attributes can be looked up without the latency or resource demand associated with graph navigation or join queries.

FIG. 3 is a high-level block diagram of object classes in an example identity management graph 173. The vertices are organized in classes including users, roles and assignments (i.e., in a user-role-assignment use case). There will typically be many users. A user can also have several roles and multiple assignments can be associated with any role. Roles can also be shared by more than one user and assignments can be related to more than one role.

Relationships in FIG. 3 are unidirectional and paired, though they could be implemented as bi-directional relationships. In the paired relationships, a relationship pair connects a two vertices with forward and reverse edges, allowing the relationship pair can be traversed both directions, starting from either vertex and using relationship data available in the starting vertex. User vertex 360 is associated by a “roles” edge 350 with role vertex 340, and by a reverse “members” edge 355 from role vertex 340 to user vertex 360. Role vertex 340 is further associated by an “assignments” edge 330, from role vertex 340 to assignment vertex 320, and by a reverse “roles” edge 335.

(As often happens in programming, some terms are overloaded. In this description, variations on “role” refer to an aspect of a user's job, a class of vertices, instances of a vertex, two classes of edges, and instances of both classes of edges. We have endeavored to distinctively identify what sense of role, for instance, we are referring to, but a skilled user can find some transgressions in the description.)

Continuing the description of FIG. 3, instances of the user class of vertices are connected by edges to instances of the role class of vertices that are connected in turn to instances of the assignment class of vertices. No direct connections between user vertices and assignment vertices are supported in the example schema. The schema specifies that user vertex 360 maintains never stale cache 373. The schema interpreter 180 parses the schema and assembles data used to build and maintain cache 373. Example notification requirements 380 specify a direction of notifications from assignment class 320 to the role class 340 and on to the user class 360, which will now be discussed in greater detail.

FIGS. 4A and 4B illustrate schema excerpts used to specify objects illustrated in graph 300 of FIG. 3. FIG. 4A includes schema excerpts (177a) for user vertex 360 and relationships corresponding to user vertex 360, while FIG. 4B includes schema excerpts (177b and 177c) respectively for role vertex 340 and relationships to role vertex 340, and for assignment vertex 320 and relationships corresponding to assignment vertex 320. Features of schema 177a-c including these components and the configuration of these components are configured by schema interpreter 175 and utilized by graph manager 180 and graph application 195 in the manners described herein to conduct graph management.

The schema for user vertex 360 begins at line 0017. Throughout the schema, edges are referred to as relationships, so we switch from edges to relationships for this discussion. In the user vertex section of the schema, the role relationship is specified beginning at line 0358. In the role vertex section of the schema, the assignment relationship is specified beginning at line 0937. The specifications of never stale caches for effective roles and effective assignments begin at 0523 and 0540. The query for refreshing the never stale cache of effective roles begins at 0530 and the query for refreshing effective assignments begins at line 0547. The “role” relationship 350, described as “Provisioning Roles”, begins at 0358-60 and paired reverse “members” relationship 355 is identified at line 0374.

Specification of the role vertex, not to be confused with the roles relationship, begins at line 0801 of FIG. 4B. The schema for the role vertex 340 begins at line 0806, for which “Members” relationship 355, which is described as “Role Members”, begins at lines 0836-38, and the paired reverse “roles” relationship 350 is identified at line 0848. “Assignments” relationship 330, which is described as “Managed Assignments”, begins at lines 0937-38. The schema for the role vertex specifies that a modification to or received on the assignment relationship field (lines 0937 to 0982) triggers a notification along a “members” relationship field, via the “notify” stanza on line 874. The data type in the example schema for this relationship field is an array. This array or edge container can be implemented in a table or a variable size object. In some special cases, the relationship can be 1-to-1 instead of 1-to-n, which could be implemented in an array or as a single value.

The assignment vertex (177c) section of the schema begins at 1033 and attributes of the assignment begin at line 1076. “Roles” relationship 335, which is described as “Managed Roles” begins at line 1122 and the paired reverse “assignments” relationship is identified at line 1132. The schema specifies that a change in assignment attributes (at line 1076) triggers a notification along the “roles” relationship field, at line 1110.

Specification of notifications in this and a further example include “notify”, “notifyRelationships” and “notifySelf” properties. Generally, notify and notifySelf specify whether objects that reference relationships are notified of a relationship change. In this example, IDM exposes a REST API. The edges between vertices are also exposed via this API. So doing a POST against managed/user/FRED/roles with a payload of {“ref”: “managed/role/admin”} will create an edge between the FRED (which is in upper case for ease of reading, not as normal syntax) managed user and the admin managed role. Likewise, a POST against managed/role/admin/members with a payload of {“ref”: “managed/user/FRED”} achieves exactly the same thing as the previous POST: it creates an edge between managed/user/FRED and managed/role/admin. In these example cases, we propagate signals back towards managed users, as they aggregate the effectiveRoles and effectiveAssignments properties, the state used to determine authorization decisions. This is achieved by the notifySelf and notify configurations. The notifySelf on the roles field of the managed user (0375) ensure that when the managed/user/ZZZ/roles endpoint receives a create/delete/update request, the managed user ZZZ will be told. The notify on the members field of the roles vertex (0874) ensures that when the managed/role/YYY/members endpoint is hit with a create/delete/update request, the managed user referenced in the request will be notified. In this way, we propagate signals from roles to users, not the other way round. We do this because users need to be told when their role state changes, as authorization state is derived from the referenced roles. But roles don't need to be told when their user state changes, in this example, as there is no property in the role vertex derived from the referenced users.

The next piece of this signal propagation is the “notifyRelationships”: [members]” at line 981 on the assignments relationship field on the roles vertex definition. This means that when the assignments relationship field on a role vertex is signaled (due to a change on the attributes of a referenced assignment, or because an edge has been created, or an existing edge has been deleted or updated), then this signal is propagated out of the members relationship field. In this way, any signal a role vertex field gets via its assignments relationship field (again because a new edge to an assignment has been created, an existing edge is deleted/updated, or the attribute state of a referenced assignment is changed) will be propagated on to all user vertices which are members of this role. Specification of “notifyRelationships”: [“roles”] at line 1110 of assignment 320 means that a change to an attribute field (update/add/delete) of an assignment vertex will trigger an update notification to propagate along instances of the roles relationship (including edge 335 of FIG. 3) from assignment vertex 320 to role vertex 340. Members at line 0836, described as “role members” in line 0837 corresponds with members at line 0374 of user vertex schema 177a (FIG. 4A). This means that notification of the attribute field change will propagate along instances of the members relationship (including edge 355 of FIG. 3) from roles vertex 340 to user vertex 360.

### General Example of Smart Signaling

FIGS. 5A through 5E use vertices belonging to five classes to illustrate the next-hop analysis used in smart signaling. FIG. 5A provides a graph with five vertices belonging to classes W 515, X 535, Y 555, Z 575 and Upsilon 559. There is only one vertex in each class in this simplified example, so “W” can, in varying contexts, refer either to class W or a vertex W that is an instance of a class W. We use this simplified graph and a pair of state/property/attribute changes to describe triggered notifications, propagation of notification signals, and queries to update local caches at vertex or edge instances. The purpose of notifications is to trigger queries to update local caches. Notifications to nodes, especially leaf nodes, that don't or shouldn't update their local caches can be avoided.

First, reiterating some vocabulary. A vertex can alternatively be referred to as a node, entity or object. When discussing a schema for vertex and edge objects, we refer to classes, relationships and properties. When discussing instances of objects that implement the schema, we refer to a vertex, an edge, and a state/property/attribute of either a vertex or an edge. Schemas for either classes or relationships can define local caches of effective properties. Effective properties are derived across relationships from properties of other objects. The caches are populated by queries for effective properties.

FIGS. 5B through 5E provide partial example schemas for classes W, X, Y and Z respectively. There is no example schema for class Upsilon. In the partial example schemas, relationship names incorporate vertex names. For instance, the paired relationships between W and X are WXRel and XWRel in this example schema. This naming is used because the vertex classes have purely abstract names, so no meaningful relationship names can be assigned. In production schemas, more meaningful names are used, such as an “ownerOfOrg” relationship between a “user” and an “organization”.

In example schema FIG. 5E, vertices of root class W are defined as caching UAttribute from vertices of class Upsilon, but not ZAttribute from Z. In example updates, a pair of notifications are triggered by changes in properties (aka states) of two vertices, a change to UAttribute in vertex Upsilon and to ZAttribute in vertex Z. Notifications in this example flow towards W, which caches UAttribute but not ZAttribute. A notification of a state change in Upsilon due to an update of UAttribute should reach W and cause W to execute a query to update its cache, because it caches UAttribute. In contrast, there is no reason for notification of a state change in Z due to an update of ZAttribute to reach W or to cause W to execute a query to update its cache, because W does not cache ZAttribute or any other property of Z.

Next-hop analysis handles propagation of notification of the updates or state changes to Upsilon/UAttribute and Z/ZAttribute as follows, beginning with Upsilon. Vertex Upsilon has a notify relationship (“notifyRelationships”) over the relationship UXRel that is defined in a schema (not in the figures), which invokes next-hop analysis of the schema for class X. The schema for class X (FIG. 5D) includes a notify relationship with vertices of class W across relationship XWRel. A notification from Upsilon is forwarded by vertices of class X, so Upsilon forwards the notification to X. The notification signals X that a change has taken place. Upsilon's notification does not need to specify the particular change; it can just signal a change and trigger vertices that cache its properties to query its properties. In alternative implementations, the notification could include a key or a key:value pair that identifies what has changed, which could reduce the need for a query. When vertex X receives the notification from Upsilon, the schema for its class (FIG. 5D) indicates a notify relationship with vertices of class W, which invokes next-hop analysis of the schema for class W. The schema for class W (FIG. 5E) includes a cache of “effectiveFields”. The query in “queryConfig” that derives the cache values reaches across relationships WXRel and XUpsilonRel to retrieve and cache all “referencedObjectFields”: [*]. A notification from Upsilon is of interest to vertices of class W, so X forwards the notification to W.

Vertex Z has a notify relationship over the relationship ZYRel as defined in schema FIG. 5B, which invokes a next-hop analysis of the schema for class Y. Vertices of class Y have a notify relationship (FIG. 5C) over YXRel, so Z sends a notification signal to Y. When vertex Y receives the notification from Z, the notifyRelationship within YXRel of its schema (FIG. 5C) invokes next-hop analysis of the schema for class X. The schema for class X (FIG. 5D) does not include a notifyRelationship within the section for relationship XWRel. X also does not have a cache that derives values from Z. Accordingly, despite vertices of class Y being configured to forward notifications to X, smart signaling averts propagation of the notification from Z by Y to X.

Diverging from the schema in FIG. 5D, a different schema would have allowed class X to satisfy the next-hop analysis from Y. For instance, XWRel in FIG. 5D alternatively could have been configured with a notifyRelationship:[“XWRel”]. Then, the notification would have been forwarded to by Y to X and a next-hop analysis from class X performed for potential propagation of the notification signal to root class W. The schema for class W (FIG. 5E, unchanged even in this alternative) includes a cache of “effectiveFields” that queries [“WXRel”, “XUpsilonRel”], but not a query that includes [“XYRel”], so W's cache cannot query over Y for properties of Z. The notification over Y from Z is not an interest expressed by any RDVP caches defined on W, so W is not a consumer and X would not forward the notification to root class W.

In summary, this example illustrates propagation of signals when next-hop analysis reveals a propagator and when it reveals a cache at the next hop. The example notifications originate from leaf nodes Z and Upsilon. Classes Y and X are propagators towards W. Relationships of Z and Upsilon with Y and X trigger propagation of notification signals. Class W is not a propagator, because it is a root node. Notification signals are selectively propagated to W, based on what W caches, as indicated by queryConfig in W's schema.

With the above generic scenario in mind, the remaining discussion covers three scenarios: providing software access with a user-role-applications class arrangement, and managing organizations with a user-organization class arrangement. Applicability to the Internet of Things (IoT) also is raised.

The scenarios employ examples to illustrate different advantages. The software access scenario illustrates the advantage of avoiding redundant signaling. The managing organization scenario illustrates the advantage of avoiding unnecessary signaling.

The technology is not limited to the particular following scenarios, and the advantages are not limited to the scenarios used to demonstrate those examples.

### Managing Software Access

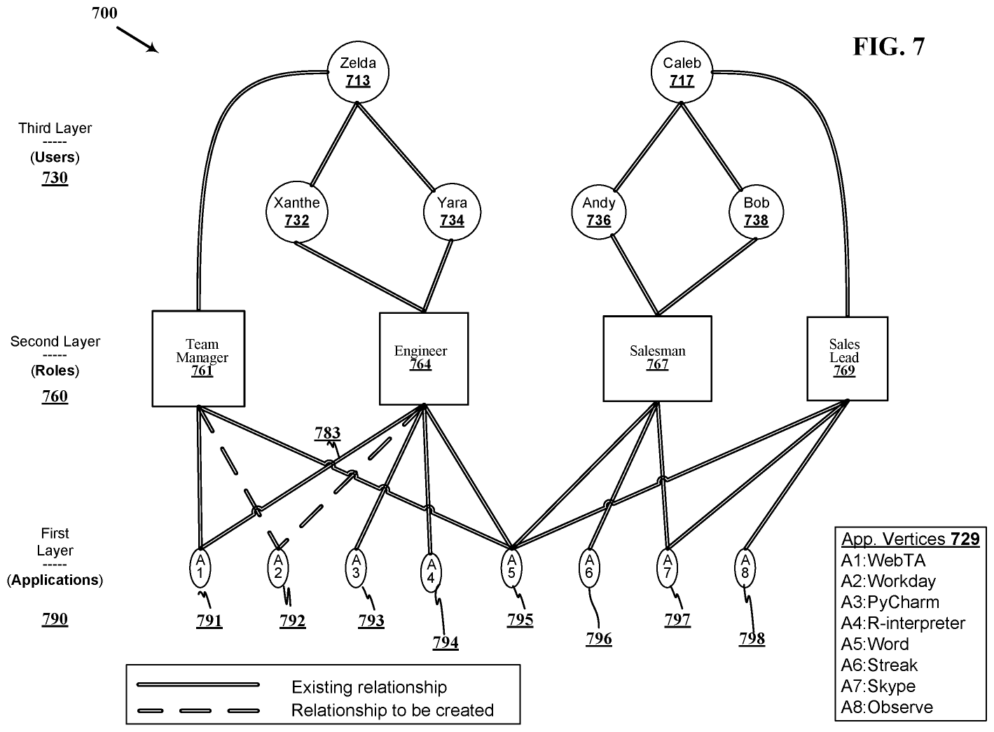

FIG. 7 is an example graph with supervisor-worker relationships and simplified entitlement to access SaaS applications. This graph can be defined by extending the user-roles-assignments schema. The user vertices can be connected to model and implement assignments, applications, and reporting relationships. Graph 700 includes three classes of applications 790, roles 760 and users 730. The users are in two layers for supervisors (713, 717) and workers (732, 734, 736, 738). Users derive their access to applications from their roles.

Third layer 730 contains user vertices Andy 736, Bob 738, Caleb 717, Xan the 732, Yara 734 and Zelda 713 which represent users with those respective names. Second layer 760 contains the role vertices team manager 761, engineer 764, salesman 767 and sales lead 769 which represent roles of those respective titles. First layer 790 contains application vertices A1 791 through A8 798 which represent software applications as listed in legend 729. All relationships are represented by edges between vertices. One such relationship, that lies between A2 792 and engineer 764, is relationship 783.

In this scenario, suppose that users Xanthe and Yara are engineers who both report to user Zelda, the team manager, and users Andy and Bob are salesmen who report to Caleb, the sales lead.

Further in this example, users require access to software to perform their jobs. To the engineers, the organization currently provides PyCharm (Python programming language Integrated Development Environment), R interpreter (interpreter for a data-science programming language). Salesmen are provided Streak (cloud customer relationship management software), and Skype (telecommunication software). Team managers and engineers are both provided with WebTA (in house time and attendance tracking software), and the sales lead is provided with Observe (call center performance monitoring software). Everyone is provided Microsoft Word (word processing software). For engineering teams, the organization has switched former timesheet keeping software to Workday but has not yet provided access to any users.

Application vertices in first layer 790 comprises references to role vertices in second layer 760 and attributes as name-value pairs. Role vertices in second layer 760 comprises references to user vertices in third layer 730 and application vertices in first layer 790. User vertices in third layer 730 are related to roles and have an RDVP cache of derived values from applications through roles. The derivation of values can occur based on a notification received through a role vertex that the user vertex is related to, and an application vertex that the role vertex is related to.

### Examples for Changes in Edges—Time Keeping Software Update

As an example of how smart signaling can reduce redundant notifications when a relationship is changed, graph 700 is updated to include the newly available Workday software. Specifically, application vertex A2 792, which represents Workday, is assigned a relationship with engineer 764. This occurs by creating a new relationship between application vertex A2 792 and engineer 764. The user-roles-assignments schema closely resembles the user-roles-assignments schema, so it is not illustrated in the figures.

The schema for the new relationship of application A2 792 to role engineer 764 includes “notifySelf” on “RoleAppRel” and “notify” on “AppRoleRel”, as described in the previous general example. Creation of the edge generates a notification, which triggers a next-hop analysis. The roles vertex is a propagator, so the notification is forwarded to the role vertex. From the engineer role vertex 764, the graph manager performs another next-hop analysis. The target vertices related to engineer role 764 are user vertices Xanthe 732 and Yara 734, so next-hop analysis is performed for the user class.

The schema for the class user defines an RDVP cache of effectiveApplications that derives values over a path of [“roles”, “applications”]. Because engineer 764 received the update notification from A2 792, a graph manager determines that the notification will the satisfy “roles”, “applications” path requirements. Therefore, Xanthe 732 and Yara 734 are consumers affected by a current signal path condition. Since at least one of the conditions of the two part next-hop analysis is satisfied, the next-hop analysis is satisfied. Therefore, the notification is forwarded to Xanthe 732 and Yara 734.

Again, in this graph Xanthe and Yara report to Zelda. From Xanthe 732, the graph manager performs an abbreviated next-hop analysis with user vertex Zelda 713 as a target vertex. Because the user schema for Xanthe 732 does not have a notifyRelationships: [“manager”] property on the roles relationship, Xanthe 732 does not notify Zelda 713. This abbreviated analysis does not require consideration of propagator and consumer status of Zelda. The abbreviated next-hop analysis at user vertex Xanthe 732 also applies to user vertex Yara 734, when deciding whether to forward the notification from Yara to user vertex Zelda 713. Thus, the notification signal does not propagate to user vertex Zelda 713.

Signal propagation is only considered if one of the changed fields on the vertex following signal receipt has a notifyRelationships stanza, where the set of changed fields always includes the relationship field through which the signal was received. When Zanthe is signaled from role Engineer, Zanthe will receive the signal through the roles relationship. Because this relationship does not have a notifyRelationships stanza, and no other fields changed in Zantha following signal receipt have a notifyRelationships stanza, the signal is not propagated, and ‘smart signaling’ does not have to be engaged.

It would be possible, on a User object, to define a reportsApps RDVP, which specify referencedRelationshipFields: [“reports”], and referencedObjectFields: [“effectiveApplications”], thereby harvesting the effectiveApplications state of all reports. To make this work, you would have to put a notifyRelationships: [“manager”] on the effectiveApplications RDVP. In this case, Xanthe would get the signal initiated by the new edge from A2 to Engineer, and update their effectiveApplications to reflect the newly-acquired Workday app. Then, because efffectiveApplications on Xanthe will have changed, and because effectiveApplications has a notifyRelationships: [“manager”], the signal would be propagated onward to Zelda, and Zelda could update its reportsApps RDVP to reflect that Xanthe now has access to Workday.

Updating a property of an application linked through the role vertex team manager 761 to user vertex Zelda 713 produces a different result, because the modified property of the application object has a notifyRelationships:[“roles”]. Then the propagation of the notification signal will be initiated to all referenced roles—in this case, to Team Manager. Roles have a notifyRelationships:[“members”] on their applications relationship, which invokes smart-signaling analysis for propagation to Zelda. Similar to FIG. 4A lines 0547-0549, Zelda's user vertex includes a queryConfig parameter [“roles”, “applications”]. A vertex of the user class is a consumer of updates to connected vertices of the applications class, so a notification of adding A2 792 will be forwarded by role team leader 761 to user Zelda 713, after passing the next-hop analyses.

Removing an edge follows a similar analytical approach. For example, assume engineers are no longer provided access to the obsolete WebTA timekeeping software A1 791. However, the organization is concerned about future audits, and because not all records have been converted to the format for Workday, team managers must still have access to the time sheets that were filed under WebTA 791. To reflect this example, relationship 783 is deleted, but other relationships remain unchanged.

When the deletion of relationship 783 occurs, role vertex engineer 764 receives an edgeDeleted signal, as dictated by “notify” and “notifySelf” configurations. Role vertex engineer 764 updates all RDVPs derived from the relationship through which it received the signal. So if roles defined an RDVP called, e.g., roleApplications, with a referencedRelationshipFields of [“applications”], this RDVP would be updated. But roles do not define such an RDVP. But they do have a notifyRelationships [“members”] on applications, the relationship field through which the signal was received, so they will read the contents of the relationship field(s) specified in notifyRelationships (i.e. members), getting the edges linking to all referenced users (Xanthe and Yara), and conduct smart-signaling next hop analysis to determine whether each user will act upon the signal. Role vertices have a notifyRelationships: [“members”] configuration with user vertices, so a next-hop analysis is performed. User vertices Xanthe 732 and Yara 734 are configured to derive their RDVP cache from applications. Therefore, the notification is forwarded to user vertices Xanthe 732 and Yara 734. However, the notification is not forwarded from user vertices Xanthe 732 and Yara 734 to their boss user vertex Zelda 713, as explained above. Smart signaling averts the notification.

On another path, the relationship between vertex A1 791 and team manager 761 remains unmodified, so no notification of the deleted edge is forwarded to user vertex Zelda 713.

While the above examples are used to demonstrate the technology, the technology disclosed herein is not limited to these examples. The technology using the next-hop analysis does not necessarily exclude situations where the whole use-case structure is traversed. For example, if Word is updated and application vertex A5 795 updates its version number, then based on the structure of graph 700, every vertex is eventually signaled. The steps in the full-tree traversal still use the next-hop analysis to determine if any of the conditions are met.

### Organization Hierarchy Models

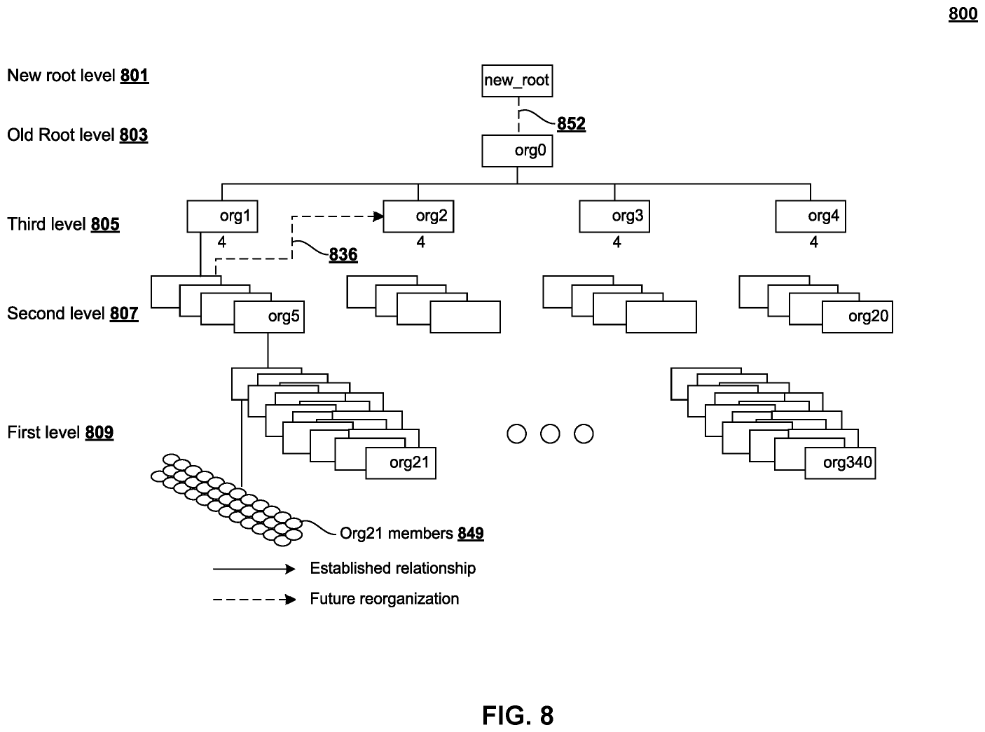

FIG. 8 illustrates an organization chart and graph that involves signaling across multiple organizations and members of organizations. The scenario can illustrate, by examples of adding a new root and adding an owner of an organization, how smart signaling can reduce unnecessary notifications.

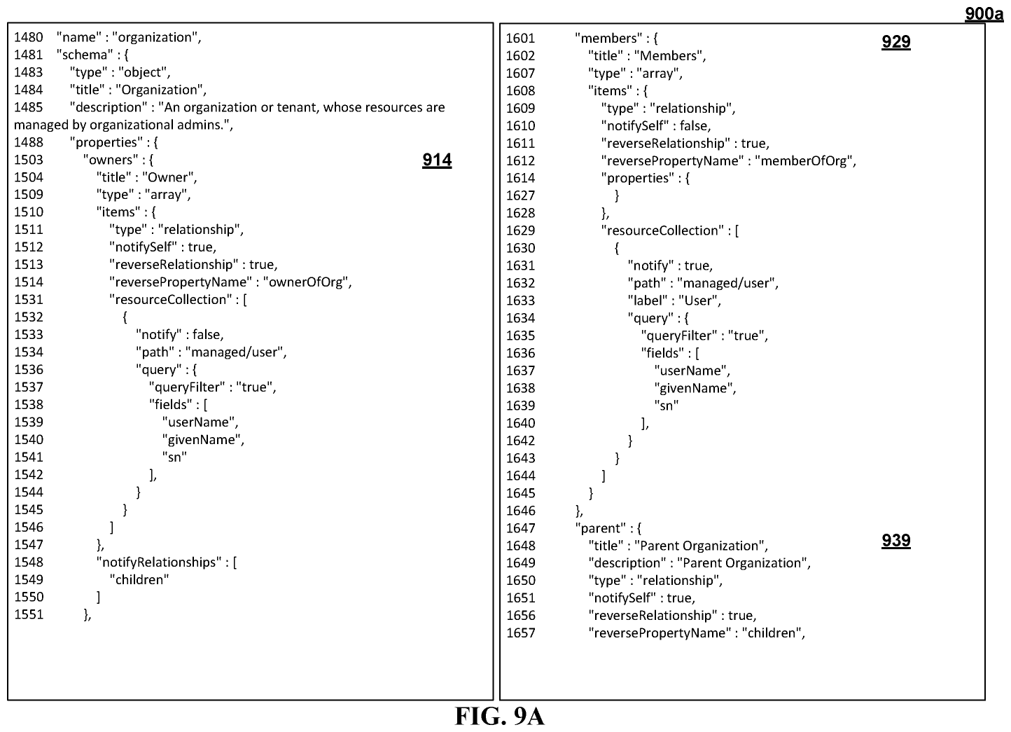

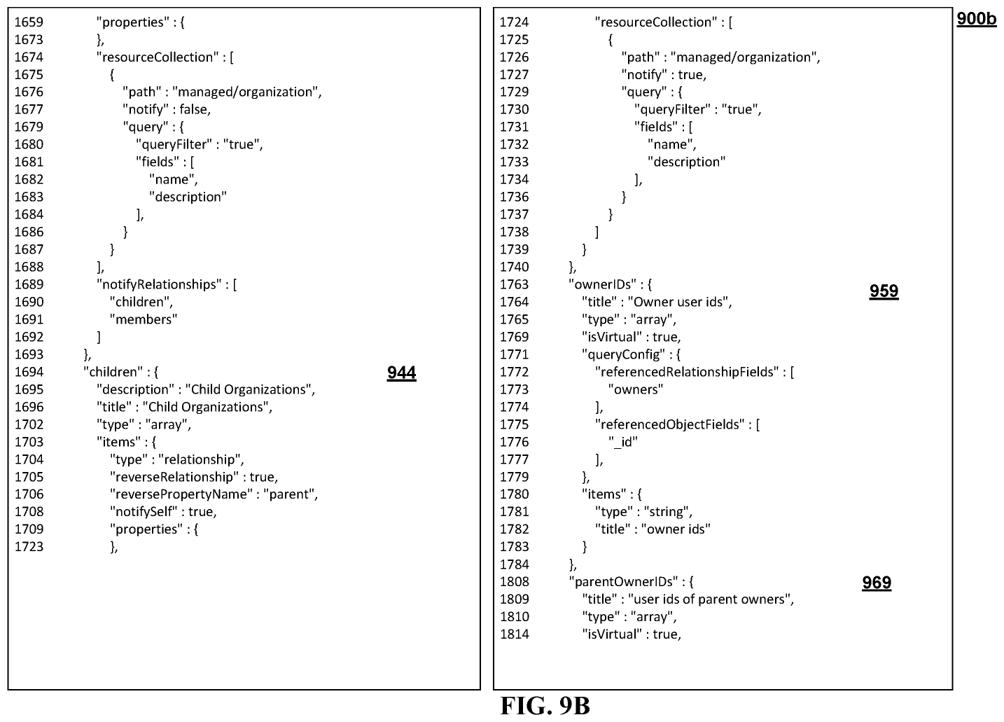

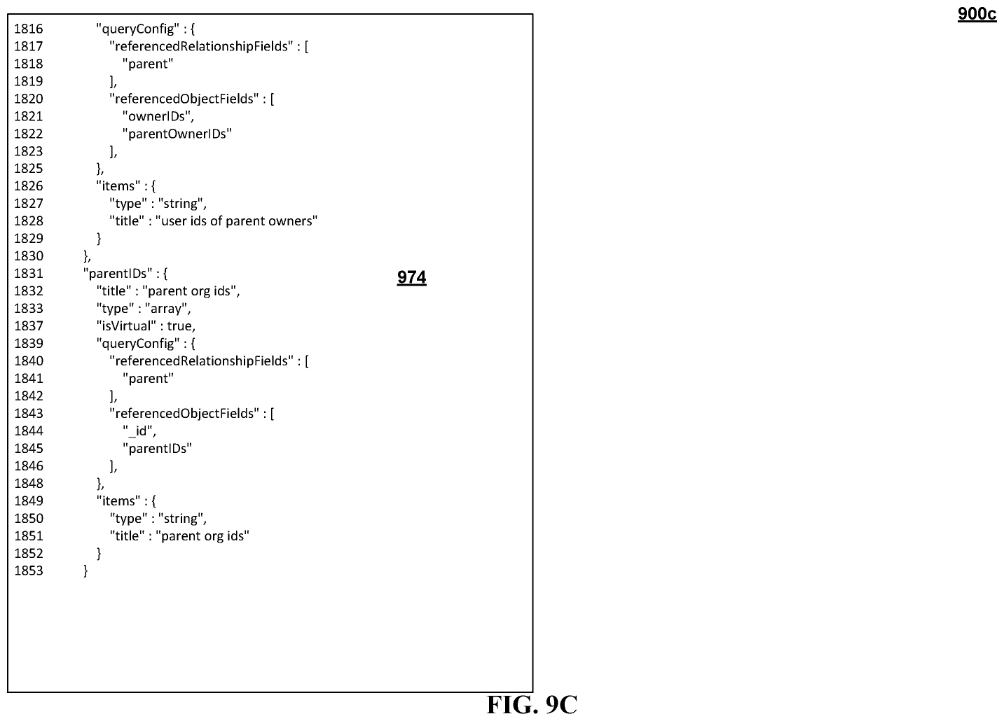

Suppose there is a large diet organic food company named “Org 0”. It has subsidiary organizations dedicated to different food-related businesses, named Org 1, Org 2, Org 3 through Org 340. Suppose Org 0 is acquired by a holding company called New Root. In FIGS. 9A-9B vertex data before and after new_root 801 is added are exampled.

Organization chart 800 includes organization and user objects/vertices and relationships among the objects. Organization objects are arranged in levels, from leaf to root including first level 809, second level 807, third level 805, old root level 803 and new root level 801. The user objects are members of organizations. Members 849 belong to org21. Relationships include established relationships, as represented by solid lines, and future reorganizations 836 and 852, as represented by dashed lines.

First level 809 represents sets of 256 organizations managed by a second level organization. There are four organizations in this level, org21-org340.

Second level 807 illustrates four sets of organizations, org5-org20, managed by a third level 805 organizations org1-org94.

Old root level 803 has one organization, org0, which is the root before new_root is added at level 801. The tree generally expands from the root to leaf nodes.

Organizations have members. Members belong to the organization to which they are assigned and to parent organizations that are higher up in the organization chart.

The organization structure is fundamentally different than the structure in FIG. 3, because the parent-child relationship among organizations is recursive, without the tree having a predetermined depth and without any restriction that requires the tree to be balanced. This impacts notifications and further motivates smart signaling.

FIGS. 9A-C illustrate schema excerpts for the vertex classes “organization” and “user”. The illustrated schema extends the schema in FIG. 4, for the user-roles-assignments graph. FIGS. 9A-9C include schema excerpts for the class “organization”. Schema excerpt 900a defines properties of owners 914, members 929, and a parent organization 939. In FIG. 9B, 900b definition of parent property 939 is concluded. Properties of the “organization” children 944, ownerIDs 959, and parentOwnerIDs 969 are defined. In FIG. 9C, excerpt 900c defines properties of parentIDs 974.

The schema excerpts omit, for the sake of brevity, administrator-related properties. The administrator properties have similar configuration to owner properties.

Relationships between organizations and users are defined in the schema. In FIG. 9A, the schema for a current organization vertex includes an owners property 914 that is an array of connections between the organization vertex and user vertices of users who own the current organization. Owners are authorized to add or remove administrators of the organization that they own and any suborganization. Administrators are users who are authorized to add, remove, or update members of the organization. In some implementations, owners are not members of the organization, but administrators are. When owner and administrator relationships to an organization are updated, then the current organization and child organization vertices are notified.

Members property 929 is an array of relationships that link vertices representing users who are members to their organization.

Parent property 939 (FIGS. 9A and 9B) records a relationship connecting the current to a parent organization. The parent organization manages the current organization. Notifications follow parent-child organization relationships, as well as organization-member relationships.

Children property 944 records relationships to child organizations that the current organization manages.

OwnerIDs property 959, which includes a “queryConfig”, defines an RDVP cache of user ids (“_id”) for owners of the organization.

The owners of parent organizations are arrayed in the ParentOwnerIDs property 969 that bridges FIGS. 9B and 9C. The parentIDs RDVP has a referencedObjectFields: [“_id”, “parentIDs”] and a referencedRelationshipFields:[“parent”]. This means that the parentIDs RDVP will be calculated by traversing the parent relationship and harvesting the _id and parentIDs fields of the org reached via the parent relationship. Thus, the parentIDs of a given child org is composed of the _id of their parent, and the parentIDs of their parent. In this way, the parentIDs RDVP is propagated down the org hierarchy, augmented by the _id of the parent as the signal propagates down from parent to child. The same patten applies for the parentOwnerIDs RDVP: the parentOwnerIDs RDVP of a given child is composed of the union of the parentOwnerIDs, and ownerIDs, of their immediate parent. So as a signal propagates down the org hierarchy, each org will update their parentIDs and parentOwnerIDs RDVP, an update which will be ‘harvested’ by their children as the signal propagates down the org hierarchy.

Similarly, at the organization level instead of the user-owner level, ParentIDs property 974 defines an RDVP cache of organization IDs of parent organizations up the tree, including parentIDs of the parent organization.

Similar to the schema for a “user” class in FIG. 4A, the schema will define an ownerOfOrg property for a relationship array of organizations a user owns. A MemberOfOrg property records relationships with organizations to which the user belongs as a member. MemberOfOrgIDs property 999 defines an RDVP cache of organization IDs of the organizations to which the user belongs, as well as ParentIDs of parent organizations above the user's organization. Both types of IDs are objects of the “queryConfig”.

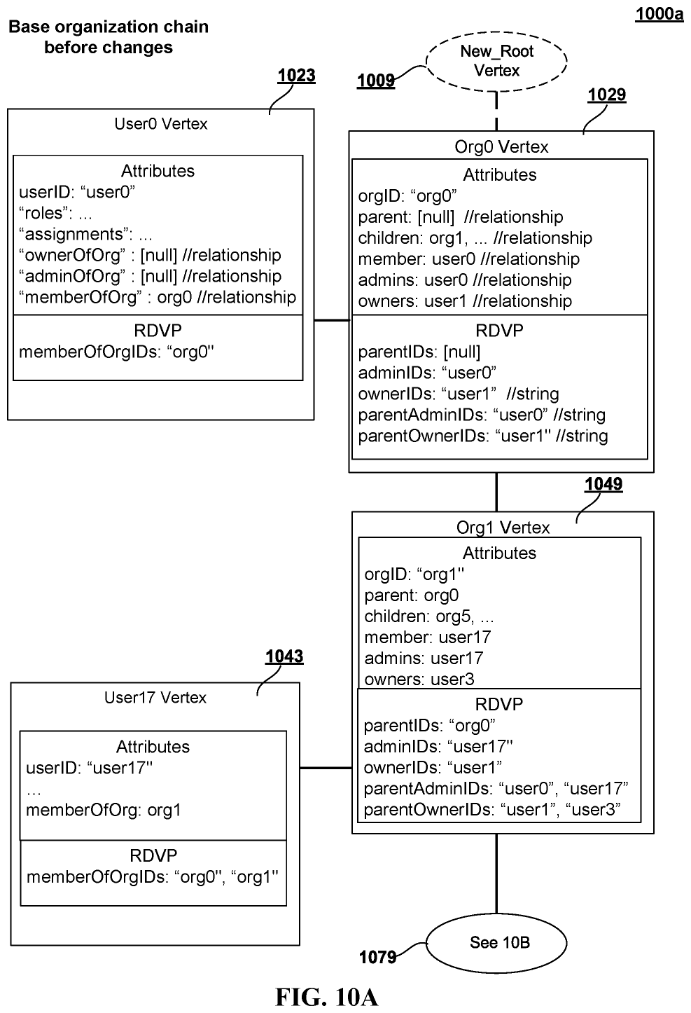

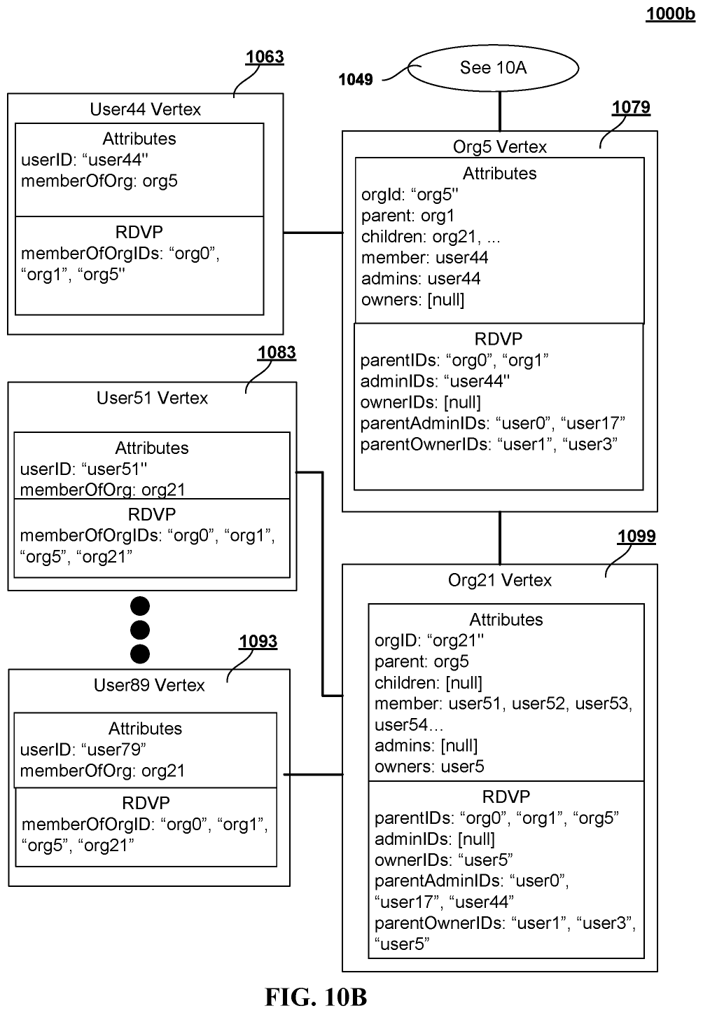

Next, we build on the graph introduced in FIG. 8 and the schema in FIG. 9 to illustrate in FIGS. 10-12 limited notification and propagation through the graph of changes in properties/states that result from adding the new_root organization as parent of org0 and adding user99 as owner of org0 propagate to vertices through the graph. The patterns of propagation into RDVP caches motive smart signaling to limit propagation of notifications.

FIGS. 10A and 10B partially illustrate organizations, users, and properties of organizations and users from the org chart in FIG. 8, consistent with the schema in FIG. 9. The four organizations (of 340) illustrated are org0 1029, org1 1049, org5 1079 and org21 1099, from the left side of FIG. 8. The new_root 1009 is in a dashed oval, indicating that it has not yet been added. The five users illustrated are user0 1023, user17 1043, user 44 1063, user41 1083, and user 89 1093. The values of properties in the nine illustrated vertices do not include any reference to “new_root”.

Organization vertices reference users that are owners, administrators, and members. Each organization also contains an RDVP cache of administrators and owners that are both from administrators or owner relationships of the current vertex, and also derived from parent organizations in the organizational hierarchy. For example, in FIG. 10A, org1 vertex 1049 has user17 as a directly assigned administrator and user3 as a directly assigned owner. Org1 vertex 1049 also derived, from org0 vertex 1029, user0 as an administrator and user1 as an owner. Therefore, the RDVP cache of org1 vertex 1049 contains the userID value of user17 vertex 1043 as an adminIDs property value and also contains the userID values of user0 vertex 1023 and user17 1043 as parentAdminIDs property values.

In FIG. 10B, org5 vertex 1079 has its own directly assigned administrator “user44” and no directly assigned owner [null]. The RDVP cache for org5 includes parentOwnerIDs “user1” and “user3”, derived from owners of org0 and org1, respectively. The parentAdminIDs are “user0” and “user17”, which are admins assigned to org0 and org1, respectively. The parentIDs of org5 are org0 and org1, before “new_root” is added.

### Example: New_Root Added

In this example, company New Root completes the acquisition of Org 0, so a new_root vertex 1009 is added as parent of the org0 vertex 1029, to reflect the acquisition.

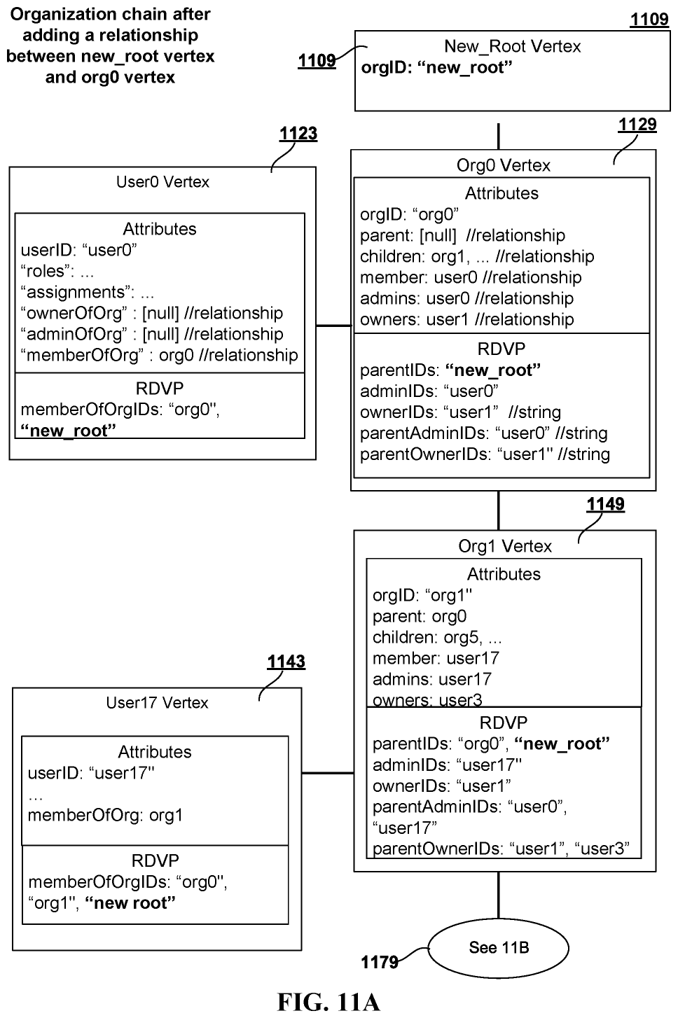

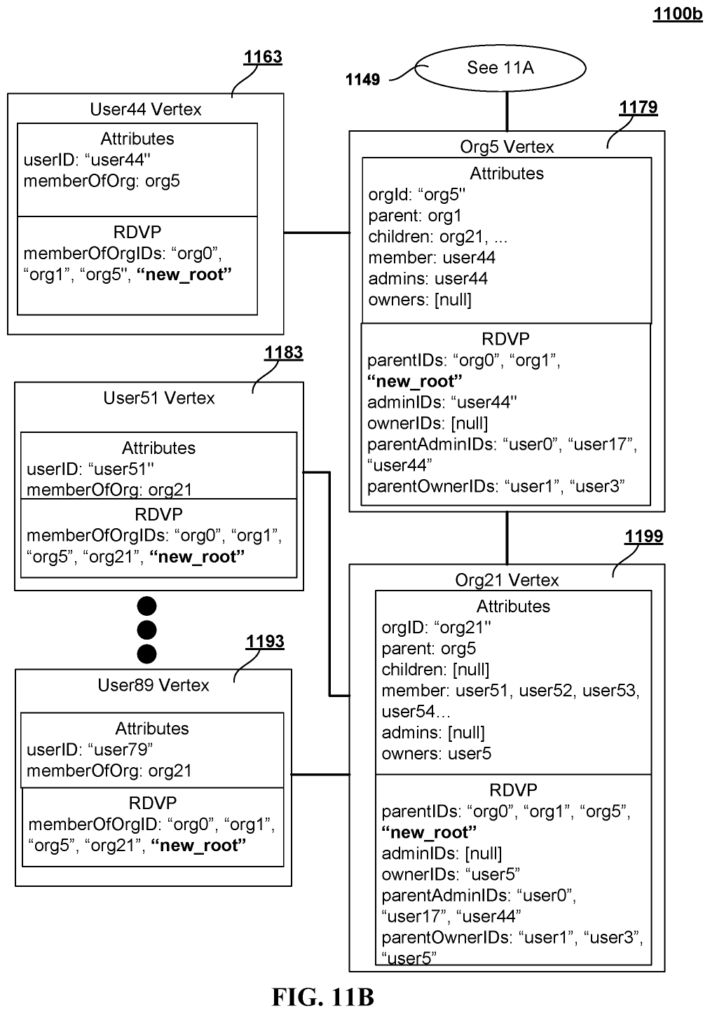

Every organization vertex and every member vertex of those organizations must be updated with new derived values to reflect the structural effect of the acquisition on the organizational hierarchy. This is because every organization in organization hierarchy chart 800 is now in the management domain of New Root, and the members of those managed organizations are effectively members of New Root's umbrella domain. The “new_root” value has been added to the RDVP cache of all the “orgN” and all the “userN” vertices in FIGS. 11A-11B.

When the new_root vertex is added and a relationship established between new_root and org0, the children relationship property of new_root is set to org0 and the parent relationship property of org0 is set to new_root. The schema for “organization” vertices has different values in “resourceCollection”: “notify” for “parent” and “children” relationship properties. Because notify is true for the children property and false for the parent property, the new_root vertex update triggers a notification instead of the org0 update. For forwarding of the notification, the situation is reversed.

Forwarding as a propagator is based on updating of the parent organization vertex, rather than updating of a child, because organization vertices cache their parents, not their children. The schema for “organization” 939, in FIG. 9A, shows the parent relationship in an org. Note the stanza notifyRelationships: [“children”, “members”]. This means that when the parent receives a signal, the signal will be propagated out of all of the ‘edges’ in the children and members relationship fields—i.e. to all children of the current org, and all members of the current org. The smart-signaling logic is engaged during the processing of this edge state, to determine if the potential-signal recipient is ‘interested’ in the signal. Note, however, that the children relationship, 944 of FIG. 9B, does not have a notifyRelationships stanza, thereby indicating that signals received through the children relationship are not propagated. The propagation configuration, from parents to children/members, reflects the business case that org membership ‘flows down’. Org0 receives notification from new_root, queries to update its parentIDs, parentOwnerIDs, and parentAdminIDs caches, and needs to decide whether to forward a notification over children and member relationships. Next-hop analysis of the schema for an organization target vertex that is the subject of the children relationship determines that “organization” has a property “parent” that defines “notifyRelationships”: [“children”, “members”], which makes children organization vertices propagators to which the new_root parent notification is forwarded. Next-hop analysis of the schema for an organization target vertex also determines that an RDVP cache “parentIDs” that queries across a parent relationship for “parentIDs”, which makes children organization vertices consumers, as well as propagators. Thus, notification that new_root was added propagates from the root organization through all organizations to the leaves. However, this could be reversed, if children organizations were cached by their parent organizations.

In an alternative design, an architect thought that org membership should ‘flow up’—i.e. that a given org ‘belongs’ to their children, not their parent. To realize this ‘inverted’ org model, all this architect had to do was to remove the notifyRelationships: [“children”, members“] stanza on the parent relationship, and add a notifyRelationships: [”parent“, “members”] on the children relationship, thereby propagating signals up the org hierarchy, not down.

To decide whether to forward a notification over member relationships, next-hop analysis of the schema for a user target vertex (1123, 1143, 1163, 1183, 1193) that is the subject of the member relationship determines that “user” has a property “memberOfOrgIDs” that queries across a member relationship for “parentIDS”, which makes user vertices consumers. When considering whether to propagate a signal to all members, the org which has received the signal from its parent, and is considering propagating the signal to its members, has updated its parentIDs RDVP as a result of signal receipt, again because the parentIDs RDVP is derived by traversing the parent relationship, and harvesting both _id and parentIDs from its parent. That way, its own parentIDs includes all of the parentIDs of its parent (the parents of its parent all the way to the root) and the _id of the parent. Thus, its own parentIDs RDVP has been updated to include the _id of the newly-added org0. So, one of the criteria to determine a potential signal recipient a ‘consumer’ has two parts: First part: this potential recipient has a RDVP whose first relationship field, as specified in referencedRelationshipFields, is the relationship field through which this potential recipient will receive the signal. The user's memberOfOrgIDs referencedRelationshipFields: [“memberOfOrg”] (the reverse of an org's members relationship) satisfies this criteria. Second part: the referencedObjectFields stanza in the potential recipient specifies a field which has changed in the potential propagator. In this case, memberOfOrgIDs specifies a referencedObjectFields of [“_id”, “parentIDs”], and, crucially, parentIDs DID change in the potential propagator, again because it includes the _id of the newly-added org0. This means that both elements of the ‘consumer’ criteria is fulfilled, so the signal is propagated. And it is precisely this second part which is NOT satisfied when a signal is propagated down the org hierarchy due to the addition of a new admin/owner. In this case, as the signal propagates down the org hierarchy, each org updates their parentAdminIDs/parentOwnerIDs RDVPs, so as each org receives this signal, and updates their own state, and considers whether to propagate this signal to all its members, smart signaling will tell it NOT to propagate to members because users are neither propagators nor consumers, the latter because they do not define an RDVP whose state is derived from a field which has changed in the potential propagator.

In FIG. 8, users are simply members of organizations. Reporting relationships are not illustrated. Thus, notification that new_root was added propagates from all organizations to their members, without needing to consider whether they also are propagators.

Smart signaling does not avert any propagation of the notification signal for addition of new_root, because this parentID gets added to the local caches of all the vertices in the figure.

After new_root is added as the top level organization, the next incremental change is to add user99 as an owner of org0.

### Example: Changes to Administrators or Owners

An owner or administrator can respectively manage administrators or users to suborganizations. To reflect that authority, if owners of an organization change, notification of the new ownership is sent to all of the sub organization vertices will acknowledge the owner's management rights. Sub-organizations cache owners of parent organizations. In contrast, users who are members of organizations have no need to cache organization ownership information. In base FIGS. 10A and 10B, the RDVP caches of user vertices 1023, 1043, 1063, 1083, 1093 (1223, 1243, 1263, 1283, 1293) do not derive any IDs of other users based on organization owner or administrator relationships. As such, smart signaling averts notification of user vertices when owners or administrators change.

In more detail, organization vertex org0 1029 updates its owners property 914 to add a relationship to a user vertex having userID value “user99”. The “notifySelf”: true definition within the owners property 914 initiates signaling of the change.

Applying smart signaling, the graph manager 180 needs to determine whether a notification of user99 1233 being added as an owner of org0 1229 should be propagated to organization vertices related as children and to user vertices that are related as members of org0.

Specifically, the “notifyRelationships”: [“children”] properties causes evaluation of whether to notify organization vertices related to org0 as children 944, which invokes next-hop analysis of the schema for class organization. The schema for class organization (FIGS. 9A-9C) includes a notify relationship with organization vertices across relationship children (9B left column), so children organizations are propagators. The schema for class organization also includes a cache of “ownerIDs” 959 across the relationship “owners”, so organizations also are consumers. Thus, org0 and its children organizations forward notification that user99 is a new owner to their children organizations due to both propagator and consumer schema definitions.

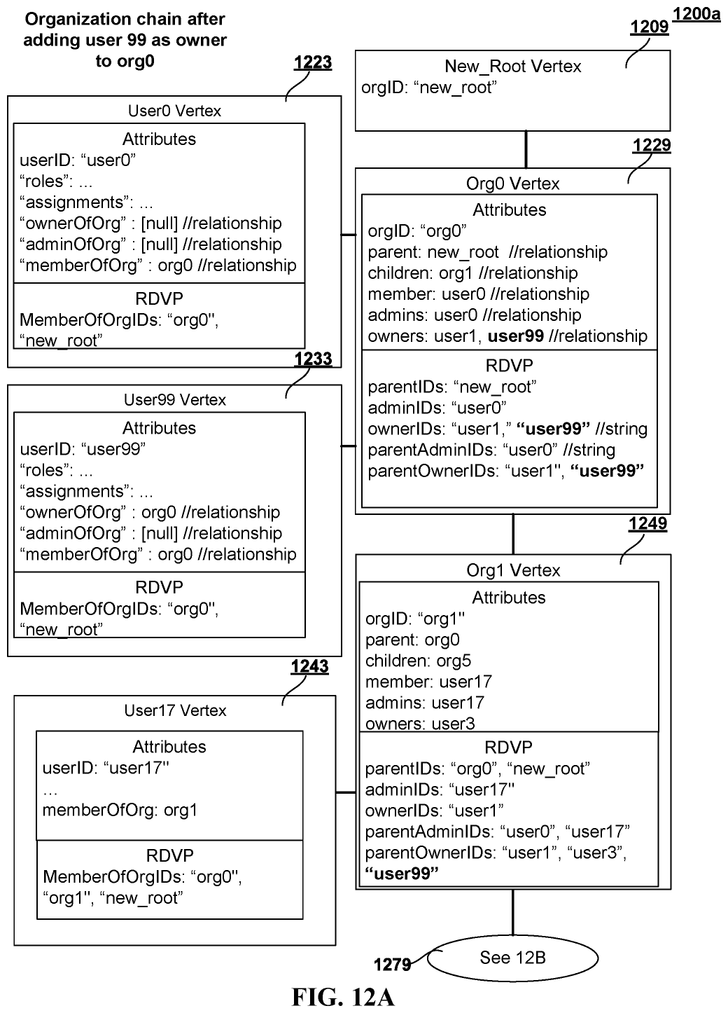

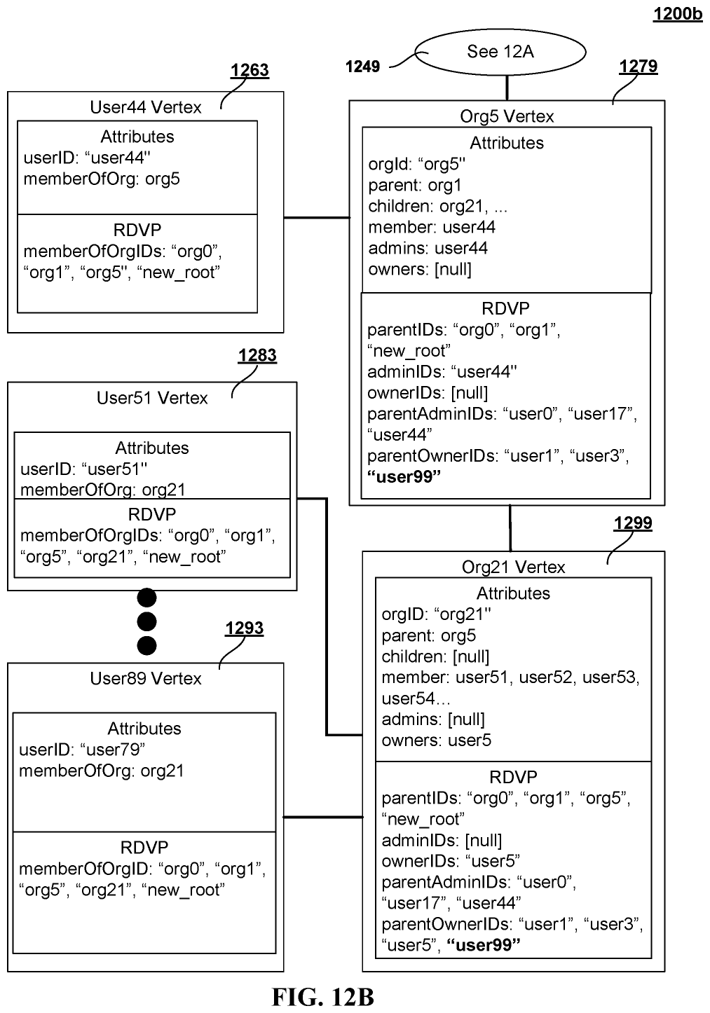

As the signal propagates down the org hierarchy, each org will receive the signal from its parent via its parents relationship field, as this field has notifyRelationships:[“children”, “members”]. The signal out of the edges in its children relationship will be propagated, because the org signal recipients are themselves propagators (because the relationship field through which they will receive the signal, parent, has a notifyRelationships stanza). When the members relationship is queried, and the set of edges pointing to users is examined by smart signaling, the analysis concludes that the potential signal recipients, users, are neither propagators (because there is no notifyRelationships stanza on the relationship field through which they would receive the signal (memberOfOrg)) nor are they consumers, because the one RDVP which users define which is derived from the org to which the user belongs, memberOfOrgIDs, specifies a referencedObjectFields of _id and parentIDs, neither of which changed in the org which is considering whether to propagate the signal, again because this org's parentAdminIDs/parentOwnerIDs RDVP changed (depending on whether an admin, or an owner(respectively) was added to an org in the hierarchy above), NOT their parentIDs. After the updating to reflect user99 owns org0, the caches of all of the organizations in FIGS. 12A-12B, from org0 to the leaf organizations (1229, 1249, 1279, 1299), list user99 in the parentOwnerIDs array. Carried over from FIGS. 11A-11B, all of the vertices in FIGS. 12A-12B cache the updated new_root organization.

FIG. 6 illustrates a graph database. Graph 600 represents a graph database that contains with vertex instances of many classes used in the earlier scenarios.

One repeated pattern of the earlier scenarios is a two or three-layer classification arrangements. Although three layers is enough to model many scenarios whether expressly taught above or colorable variations thereof, the technology is not limited to classification arrangements of just two or three “layers.” A graph database, such as graph 600, can have a multitude of vertices corresponding to a multitude of classifications, and between those classifications, there can be relationships. The technology described herein is suitable to help manage consistency in complex graph databases, such as those represented by graph 600, by using those relationships.

Additionally, although each vertex of a class type is only shown as having illustratable quantity, in practice, the number of vertices can be very large (e.g., 10 million “followers”). The technology is suited to handling large numbers of vertices.

### Computer System

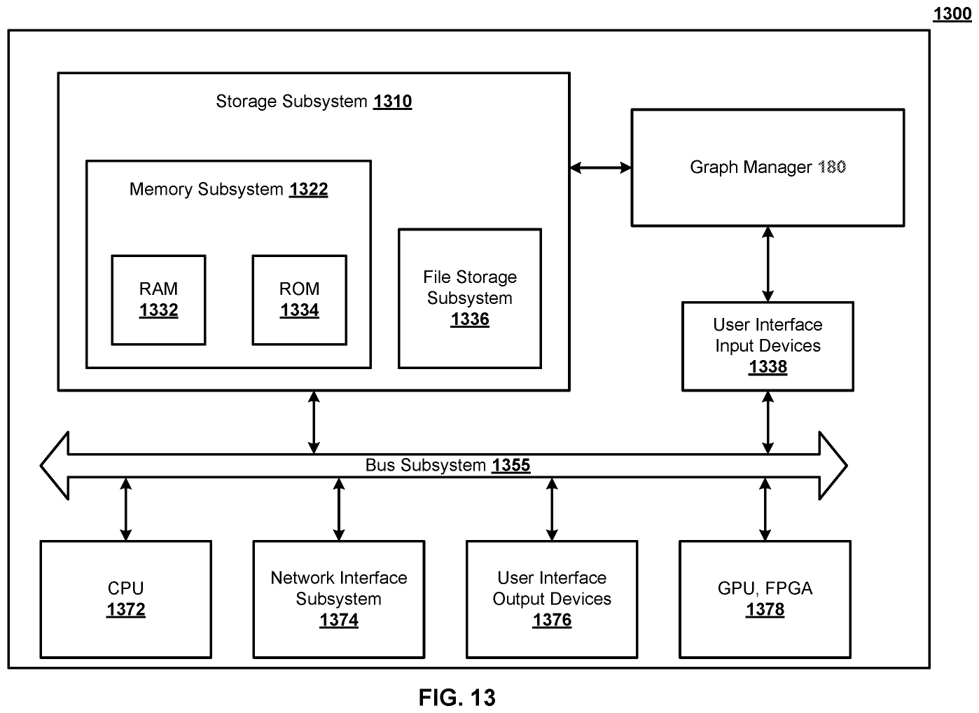

FIG. 13 is a simplified block diagram of a computer system 1300 that can be used for managing a graph by smart signaling. Computer system 1300 includes at least one central processing unit (CPU) 1372 that communicates with a number of peripheral devices via bus subsystem 1355, and graph manager 180 for signaling as described herein. These peripheral devices can include a storage subsystem 1310 including, for example, memory devices and a file storage subsystem 1336, user interface input devices 1338, user interface output devices 1376, and a network interface subsystem 1374. The input and output devices allow user interaction with computer system 1300. Network interface subsystem 1374 provides an interface to outside networks, including an interface to corresponding interface devices in other computer systems.

In one implementation, graph manager system 180 of FIG. 1 is communicably linked to the storage subsystem 1310 and the user interface input devices 1338.

User interface input devices 1338 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1300.

User interface output devices 1376 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1300 to the user or to another machine or computer system.

Storage subsystem 1310 stores programming and data constructs that provide the functionality of some or all of the modules and methods described herein. Subsystem 1378 can be graphics processing units (GPUs) or field-programmable gate arrays (FPGAs).

Memory subsystem 1322 used in the storage subsystem 1310 can include a number of memories including a main random access memory (RAM) 1332 for storage of instructions and data during program execution and a read only memory (ROM) 1334 in which fixed instructions are stored. A file storage subsystem 1336 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1336 in the storage subsystem 1310, or in other machines accessible by the processor.

Bus subsystem 1355 provides a mechanism for letting the various components and subsystems of computer system 1300 communicate with each other as intended. Although bus subsystem 1355 is shown schematically as a single bus, alternative implementations of the bus subsystem can use multiple busses.

Computer system 1300 itself can be of varying types including a personal computer, a portable computer, a workstation, a computer terminal, a network computer, a television, a mainframe, a server farm, a widely-distributed set of loosely networked computers, or any other data processing system or user device. Due to the everchanging nature of computers and networks, the description of computer system 1300 depicted in FIG. 13 is intended only as a specific example for purposes of illustrating the preferred embodiments of the present disclosed technology. Many other configurations of computer system 1300 are possible having more or less components than the computer system depicted in FIG. 13.

### Some Particular Implementations

We describe various implementations of smart signaling.

The technology disclosed can be practiced as a method, system, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

A method implementation of a portion of the technology disclosed reduces forwarding of notifications from a current vertex of a current vertex class by performing a next-hop analysis in a graph. The method operates on graph components that include vertices representing entities, and edges representing relationships, and include a schema defining the graph components, defining at least two classes of vertices, including at least one vertex class that caches relationship derived virtual properties (“RDVPs”), and defining paths along which the vertex classes propagate the notifications;

The method includes having, at the current vertex, a notification of a change. This can be received from another vertex or generated by the current the current vertex. The method includes ascertaining, from the relationships between the current vertex and target vertices that are connected in one hop, a target vertex class of the target vertices. It includes performing a next-hop analysis on the target vertex class, including tests of following conditions: a propagate to propagators condition: whether the target vertex class is configured to propagate to a further vertex the notification of the change and a propagate to consumers affected by a current signal path condition: whether the target vertex class is configured to update an RDVP cache responsive to the notification of the change received over the current signal path of vertices from an origin of the notification to the current vertex. It also includes conditionally forwarding the notification to the target vertices of the target vertex class if and only if the target vertex class satisfies at least one of the conditions above.

This method implementation and other methods disclosed can be used with one or more of the following features. This method can also include features described in connection with systems disclosed. In the interest of conciseness, alternative combinations of method features are not individually enumerated. Features applicable to methods, systems, and articles of manufacture are not repeated for each statutory class set of base features. The reader will understand how features identified in this section can readily be combined with base features in other statutory classes.

Signal initiation (the creation of a signal) occurs in one of two ways: 1. edge mutation, or 2. the update of a property on a vertex with a notifyRelationships stanza. Signal propagation (the propagation of a signal, after receipt of a signal initiated by one of the two ways described immediately above) occurs in at least the following ways: 1. the relationship field across which a signal was received itself has a notifyRelationships stanza or 2. signal receipt resulted in the update of a field, like a RDVP field, which has a notifyRelationships stanza.

A vertex can receive the notification of the change over a relationship included in the current signal path.

In implementations that the target vertex is a propagator, the target vertex class is configured with a target-to-current relationship to the current vertex and the target-to-current relationship calls for propagating the notification of the change onward over specified relationships.

The target vertices can belong to at least two target vertex classes, and the actions of determining and conditional forwarding are performed for both of the two target vertex classes.

The method can further included updating a current RDVP cache of the current vertex based on the notification, and determining, using the schema for a current vertex, specifically a notifyRelationships stanza on the updated RDVP cache, that this update should trigger the propagation of received notification. In some implementations, the schema for the current vertex includes a notifyRelationships property.

The schema can define at least two or four different vertex classes. The schema also can define a recursive relationship between vertices of a recursive vertex class, such as an organization class in which parent instances of the organization class are recursively related to child instances of the organization class.

An organization graph can define an organization class in which parent instances of the organization class are recursively related to child instances of the organization class and a user class that has relationships to the organization class including: membership in an organization; administration of the graph for the organization; and ownership of graph for the organization. In some implementations, the schema for the organization class further defines an RDVP cache that stores administrators and/or owners of parent organizations of the current vertex. Similarly, a reporting graph can recursively relate users.

In some implementations of the organization graph, the schema for the user class further defines an RDVP cache that stores ids of organizations to which a particular user belongs, including a direct organization to which the particular user belongs and parent organizations of the direct organization.

When the general method above is applied to an organization graph, the current vertex class can be the organization class and the particular target vertex class can be the user class. Then, the method further includes determining that the user class satisfies the so-called propagate to consumers affected by the current signal path condition. This can be based on the notification of the change including update to a property of a parent organization of the current vertex.

A system implementation of the technology disclosed includes one or more processors coupled to memory. The memory is loaded with computer instructions that, when executed on processors cause the processors to implement a method of maintaining a cache of effective attributes in an identity management system employing a graph.

This system implementation and other systems disclosed optionally include one or more of the features described in connection with methods disclosed. In the interest of conciseness, alternative combinations of system features are not individually enumerated. Again, features applicable to systems, methods, and articles of manufacture are not repeated for each statutory class set of base features. The reader will understand how features identified for method implementation can readily be combined with base features in other statutory classes.

Other implementations may include a non-transitory computer readable storage medium storing instructions executable by a processor to perform a method as described above. Yet another implementation may include a non-transitory computer readable storage medium storing instructions executable by a processor that, when combined with suitable hardware, produce any of the systems described herein.

This and other non-transitory computer readable storage medium implementation disclosed optionally include one or more of the features described in connection with methods disclosed. In the interest of conciseness, alternative combinations of non-transitory computer readable storage medium features are not individually enumerated. Again, features applicable to systems, methods, and articles of manufacture are not repeated for each statutory class set of base features. The reader will understand how features identified for method implementation can readily be combined with base features in other statutory classes.

Reference to computer readable medium is not intended to refer to transitory signals carrying computer instructions executable by a processor, which are within the scope of the technology disclosed. When transitory signals are deemed patentable, they will be claimed as signals or downloads or some other form of data in motion, as opposed to data at rest.

We claim as follows:

1. A method of reducing forwarding of notifications from a current vertex of a current vertex class by performing a next-hop analysis in a graph, wherein the graph includes:
graph components including vertices representing entities, and edges representing relationships; and
a schema defining the graph components, defining at least two classes of vertices, including at least one vertex class that caches relationship derived virtual properties (“RDVPs”), and defining paths along which the vertex classes propagate the notifications;
the method including:
having, at the current vertex, a notification of a change;
ascertaining, from the relationships between the current vertex and target vertices that are connected in one hop, a target vertex class of the target vertices;
performing a next-hop analysis on the target vertex class, including tests of following conditions:
propagate to propagators condition: whether the target vertex class is configured to propagate to a further vertex the notification of the change;
propagate to consumers affected by a current signal path condition: whether the target vertex class is configured to update an RDVP cache responsive to the notification of the change received over the current signal path from an origin of the notification to the current vertex; and
conditionally forwarding the notification to the target vertices of the target vertex class if and only if the target vertex class satisfies at least one of the conditions above.

2. The method of claim 1, wherein the notification was triggered by updating an attribute of a vertex connected to the current vertex over the current signal path.

3. The method of claim 1, wherein the notification was triggered by updating an attribute of the current vertex.

4. The method of claim 1, wherein the notification was triggered by updating a relationship between two vertices connected over the current signal path.

5. The method of claim 1, further including receiving the notification of the change over a relationship included in the current signal path.

6. The method of claim 1, wherein the propagate to propagators condition further includes:
the target vertex class is configured with a target-to-current relationship to the current vertex and the target-to-current relationship calls for propagating the notification of the change onward over specified relationships.

7. The method of claim 1 further including:
the target vertices belong to at least two target vertex classes; and
the actions of determining and conditional forwarding are performed for both of the two target vertex classes.

8. The method of claim 1, further including:
updating a current RDVP cache of the current vertex based on the notification; and
determining, using the schema for a current vertex class of the current vertex, that updating the current RDVP cache triggers notification to the target vertex class.

9. The method of claim 1, wherein the schema for the current vertex includes a notify relationships property.

10. The method of claim 1, wherein the schema defines at least four different vertex classes.

11. The method of claim 1, wherein the schema defines a recursive relationship between vertices of a recursive vertex class.

12. The method of claim 1, wherein the graph includes:
a schema defining an organization class in which parent instances of the organization class are recursively related to child instances of the organization class; and
defining a user class that has relationships to the organization class including at least membership in an organization, administration of the graph for the organization and ownership of graph for the organization.

13. The method of claim 12, wherein the schema for the organization class further defines an RDVP cache that stores administrators and/or owners of parent organizations of the current vertex.

14. The method of claim 12, wherein the schema for the user class further defines an RDVP cache that stores ids of organizations to which a particular user belongs, including a direct organization to which the particular user belongs and parent organizations of the direct organization.

15. The method of claim 12, wherein the current vertex class is the organization class and the particular target vertex class is the user class, further including:
determining that the user class satisfies the propagate to consumers affected by the current signal path condition, based on the notification of the change including update to a property of a parent organizations of the current vertex.

16. A non-transitory computer readable storage medium impressed with computer program instructions to reduce forwarding of notifications from a current vertex of a current vertex class by performing a next-hop analysis in a graph, the graph including:
graph components including vertices representing entities, and edges representing relationships; and
a schema defining the graph components, defining at least two classes of vertices, including at least one vertex class that caches relationship derived virtual properties (“RDVPs”), and defining paths along which the vertex classes propagate the notifications;
the method including:
having, at the current vertex, a notification of a change;
ascertaining, from the relationships between the current vertex and target vertices that are connected in one hop, a target vertex class of the target vertices;
performing a next-hop analysis on the target vertex class, including tests of following conditions:
propagate to propagators condition: whether the target vertex class is configured to propagate to a further vertex the notification of the change;
propagate to consumers affected by a current signal path condition: whether the target vertex class is configured to update an RDVP cache responsive to the notification of the change received over the current signal path from an origin of the notification to the current vertex; and
conditionally forwarding the notification to the target vertices of the target vertex class if and only if the target vertex class satisfies at least one of the conditions above.

17. The non-transitory computer readable storage medium of claim 16, wherein the notification was triggered by updating an attribute of a vertex connected to the current vertex over the current signal path.

18. The non-transitory computer readable storage medium of claim 16, wherein the propagate to propagators condition further includes:
the target vertex class is configured with a target-to-current relationship to the current vertex and the target-to-current relationship calls for propagating the notification of the change onward over specified relationships.

19. The non-transitory computer readable storage medium of 16, wherein the graph includes:
a schema defining an organization class in which parent instances of the organization class are recursively related to child instances of the organization class; and
defining a user class that has relationships to the organization class including at least membership in an organization, administration of the graph for the organization and ownership of graph for the organization.

20. A system including one or more processors coupled to memory, the memory loaded with computer instructions to reducing forwarding of notifications from a current vertex of a current vertex class by performing a next-hop analysis in a graph, the instructions, when executed on the processors, implement actions comprising:
graph components including vertices representing entities, and edges representing relationships; and
a schema defining the graph components, defining at least two classes of vertices, including at least one vertex class that caches relationship derived virtual properties (“RDVPs”), and defining paths along which the vertex classes propagate the notifications;
the method including:
having, at the current vertex, a notification of a change;
ascertaining, from the relationships between the current vertex and target vertices that are connected in one hop, a target vertex class of the target vertices;
performing a next-hop analysis on the target vertex class, including tests of following conditions:
propagate to propagators condition: whether the target vertex class is configured to propagate to a further vertex the notification of the change;
propagate to consumers affected by a current signal path condition: whether the target vertex class is configured to update an RDVP cache responsive to the notification of the change received over the current signal path from an origin of the notification to the current vertex; and
conditionally forwarding the notification to the target vertices of the target vertex class if and only if the target vertex class satisfies at least one of the conditions above.
